(19) United States
(12) Patent Application Publication
(10) Pub. No.: US 2019/0131826 A1
(43) Pub. Date: May 2, 2019

(54) FO DETECTION METHOD AND DEVICE AND SYSTEM THEREFOR

(71) Applicant: LG INNOTEK CO., LTD., Seoul (KR)

(72) Inventors: Jae Hee PARK, Seoul (KR); Yong Il KWON, Seoul (KR)

(73) Assignee: LG INNOTEK CO., LTD., Seoul (KR)

(21) Appl. No.: 16/093,783

(22) PCT Filed: Mar. 17, 2017
(86) PCT No.: PCT/KR2017/002888

§ 371 Date: Oct. 15, 2018

(30) Foreign Application Priority Data
Apr. 15, 2016 (KR) 10-2016-0046114
Jun. 1, 2016 (KR) 10-2016-0067888

(51) Int. Cl. H02J 50/60; H02J 50/80; H02J 50/12; H02J 7/02; H02J 50/90

(52) U.S. Cl. CPC H02J 50/60; H02J 50/80; H02J 50/90; H02J 7/025; H02J 50/12

(57) ABSTRACT

The present invention relates to a foreign object (FO) detection method for wireless charging, and a device and a system therefor. The FO detection method on a wireless power transmitter, according to one embodiment of the present invention, may comprise the steps of: receiving a second packet comprising a second reference quality factor value; determining a threshold by using the second reference quality factor value; measuring the current quality factor value; and detecting an FO on the basis of the threshold and the current quality factor value. Thus, the present invention has the advantage of enabling an FO to be more effectively detected.

### TECHNICAL FIELD

Embodiments relate to a wireless power transmission technique, and more particularly, to an FO detection method in a wireless charging system and a device and system therefor.

### BACKGROUND ART

Recently, with rapid development of information and communication technology, a ubiquitous society based on information and communication technology is being established.

In order for information communication devices to be connected anywhere and anytime, sensors with a built-in computer chip having a communication function should be installed in all facilities throughout society. Accordingly, power supply to these devices or sensors is becoming a new challenge. In addition, as the types of mobile devices such as Bluetooth handsets and iPods, as well as mobile phones, rapidly increase in number, charging the battery has required time and effort. As a way to address this issue, wireless power transmission technology has recently drawn attention.

Wireless power transmission (or wireless energy transfer) is a technology for wirelessly transmitting electric energy from a transmitter to a receiver using the induction principle of a magnetic field. In the 1800s, an electric motor or a transformer based on the electromagnetic induction principle began to be used. Thereafter, a method of transmitting electric energy by radiating a high-frequency wave, microwave, or an electromagnetic wave such as laser was tried. Electric toothbrushes and some electric shavers are charged through electromagnetic induction.

Wireless energy transmission schemes introduced up to now may be broadly classified into electromagnetic induction, electromagnetic resonance, and RF transmission using a short-wavelength radio frequency.

In the electromagnetic induction scheme, when two coils are arranged adjacent to each other and current is applied to one of the coils, a magnetic flux generated at this time generates electromotive force in the other coil. This technology is being rapidly commercialized mainly for small devices such as mobile phones. In the electromagnetic induction scheme, power of up to several hundred kilowatts (kW) may be transmitted with high efficiency, but the maximum transmission distance is less than or equal to 1 cm. As a result, the device should be generally arranged adjacent to the charger or the floor.

The electromagnetic resonance scheme uses an electric field or a magnetic field instead of using an electromagnetic wave or current. The electromagnetic resonance scheme is advantageous in that the scheme is safe to other electronic devices or the human body since it is hardly influenced by the electromagnetic wave. However, this scheme may be used only at a limited distance and in a limited space, and has somewhat low energy transfer efficiency.

The short-wavelength wireless power transmission scheme (simply, RF transmission scheme) takes advantage of the fact that energy can be transmitted and received directly in the form of radio waves. This technology is an RF power transmission scheme using a rectenna. A rectenna, which is a compound of antenna and rectifier, refers to a device that converts RF power directly into direct current (DC) power. That is, the RF method is a technology for converting AC radio waves into DC waves. Recently, with improvement in efficiency, commercialization of RF technology has been actively researched.

The wireless power transmission technology is applicable to various industries including IT, railroads, and home appliance industries as well as the mobile industry.

When there is a conductor, i.e., a foreign object (FO) other than the wireless power receiver in a wireless charging area, an electromagnetic signal transmitted from the wireless power transmitter may be induced in the FO, thereby raising the temperature. The FO may include, for example, a coin, a clip, a pin, and a ballpoint pen.

If there is an FO between the wireless power receiver and the wireless power transmitter, not only does the wireless charging efficiency drop significantly, but also the temperature of the wireless power receiver and the wireless power transmitter may rise together due to the increase of the temperature around the FO. If the FO located in the charging area is not removed, waste of power may be incurred, and damage may be caused to the wireless power transmitter and the wireless power receiver due to overheating.

Therefore, detecting an FO located in the charging area is becoming an important issue in the field of wireless charging technology.

### DISCLOSURE

### Technical Problem

Therefore, the present disclosure has been made in view of the above problems, and embodiments provide an FO detection method for wireless charging and a device and system therefor.

Embodiments provide a wireless power transmitter configured to detect an FO based on a second reference quality factor value received from a wireless power receiver.

Embodiments provide an FO detection method capable of preventing failure to detect an FO by adaptively determining a threshold for FO detection according to a component factor of a wireless power transmitter, and a device and system therefor.

The technical objects that can be achieved through the embodiments are not limited to what has been particularly described hereinabove and other technical objects not described herein will be more clearly understood by persons skilled in the art from the following detailed description.

### Technical Solution

Embodiments provide an FO detection method for wireless charging and a device and system therefor.

In one embodiment, a method of detecting a foreign object (FO) by a wireless power transmitter includes receiving a second packet including a second reference quality factor value, determining a threshold using the second reference quality factor value, measuring a current quality factor value, and detecting an FO based on the threshold and the current quality factor value.

Here, the second packet may further include a predetermined mode value indicating that the second reference quality factor value is a reference quality factor value corresponding to presence of the FO in a charging area.

In addition, the second packet may be received in a negotiation phase.

In addition, when the FO is detected in the negotiation phase, a state of the wireless power transmitter may transition to a selection phase.

In addition, when the FO is not detected in the negotiation phase, a state of the wireless power transmitter may transition to a power transfer phase.

The method may further include, when the FO is not detected, performing a calibration phase of calculate a power loss between a wireless power receiver having transmitted the second packet and the wireless power transmitter prior to transition to the power transfer phase.

In addition, the threshold may be determined by reflecting a design factor corresponding to the wireless power transmitter in addition to the second reference quality factor value.

In an example, the design factor may be a constant value for correcting a measurement tolerance of a quality factor value with respect to a test wireless power transmitter.

In another example, the design factor may be a constant value determined based on at least one of a power class of the wireless power transmitter, a characteristic of a transmission coil mounted on the wireless power transmitter, and an arrangement of the transmission coil.

The method may further include, when the FO is not detected, transmitting an ACK message to a wireless power receiver having transmitted the second packet and then controlling charging of the wireless power receiver to be started.

The method may further include, when the FO is detected, transmitting a NAK message to a wireless power receiver having transmitted the second packet and then entering a selection phase to control power transmission to the wireless power receiver to be interrupted.

The method may further include, when the FO is not detected, recording, in a predetermined quality factor table, at least one of a receiver identifier corresponding to a wireless power receiver having transmitted the second packet, the second reference quality factor value, the threshold, and the current quality factor value.

In addition, when the wireless power receiver is reconnected, the FO may be detected with reference to the quality factor table.

In another embodiment, a foreign object (FO) detection device includes a communication unit configured to receive a second packet including a second reference quality factor value, a determining unit configured to determine a threshold using the second reference quality factor value, a measurement unit configured to measure a current quality factor value, and a detection unit configured to detect an FO based on the threshold and the current quality factor value.

Here, the second packet may further include a predetermined mode value indicating that the second reference quality factor value is a reference quality factor value corresponding to presence of the FO in a charging area.

In addition, the second packet may be received through in-band communication in a negotiation phase.

The FO detection apparatus may further include a controller configured to make a state of the wireless power transmitter transition to a selection phase when the FO is detected in the negotiation phase.

The FO detection apparatus may further include a controller configured to make a state of the wireless power transmitter transition to a power transfer phase make when the FO is not detected in the negotiation phase, and a power transmission unit configured to transmit wireless power to a wireless power receiver having transmitted the second packet according to a control signal of the controller.

The FO detection apparatus may further include a correction unit configured to calculate a power loss between a wireless power receiver having transmitted the second packet and the wireless power transmitter prior to transition to the power transfer phase when the FO is not detected.

In addition, In addition, the determination unit may determine the threshold further using a preset design factor corresponding to the wireless power transmitter.

In an example, the design factor may be a constant value for correcting a measurement tolerance of a quality factor value with respect to a test wireless power transmitter.

In another example, the design factor may be a constant value determined based on at least one of a power class of the wireless power transmitter, a characteristic of a transmission coil mounted on the wireless power transmitter, and an arrangement of the transmission coil.

When the FO is not detected, an ACK message may be transmitted to a wireless power receiver having transmitted the second packet and charging of the wireless power receiver may be started.

In addition, when the FO is detected, a NAK message may be transmitted to a wireless power receiver having transmitted the second packet and then power transmission to the wireless power receiver may be interrupted by entering a selection phase.

The FO detection device may further include a memory for recording a predetermined quality factor table, the predetermined quality factor table including at least one of a receiver identifier corresponding to a wireless power receiver having transmitted the second packet, the second reference quality factor value, the threshold, and the current quality factor value last measured according to the wireless power receiver.

In addition, when the wireless power receiver is reconnected, the detection unit may detect the FO with reference to the quality factor table.

In another embodiment, there is provided a computer-readable recording medium having recorded thereon a program for executing any one of the above-described FO detection methods.

The above-described aspects of the present disclosure are merely a part of preferred embodiments of the present disclosure. Those skilled in the art will derive and understand various embodiments reflecting the technical features of the present disclosure from the following detailed description of the present disclosure.

### Advantageous Effects

The method, device and system according to the embodiments have the following effects.

Embodiments provide an FO detection method for wireless charging and a device and system therefor.

Embodiments provide a wireless power transmitter configured to detect an FO based on a second reference quality factor value received from a wireless power receiver.

Embodiments provide an FO detection method capable of preventing failure to detect an FO by adaptively determining a threshold for FO detection according to a component factor of a wireless power transmitter, and a device and system therefor.

Further, according to embodiments, FO detection errors may be minimized. Thereby, unnecessary waste of power and damages to equipment may be minimized.

It will be appreciated by those skilled in the art that that the effects that can be achieved through the embodiments of the present disclosure are not limited to those described above and other advantages of the present disclosure will be more clearly understood from the following detailed description.

### DESCRIPTION OF DRAWINGS

FIG. 1 is a block diagram illustrating a wireless charging system according to an embodiment.

FIG. 2 is a block diagram illustrating a wireless charging system according to another embodiment.

FIG. 3 is a diagram illustrating a detection signal transmission procedure in a wireless charging system according to an embodiment.

FIG. 4 is a state transition diagram illustrating a wireless power transmission procedure defined in the WPC standard.

FIG. 5 is a state transition diagram illustrating a wireless power transmission procedure defined in the WPC (Qi) standard.

FIG. 6 is a block diagram illustrating a structure of a wireless power transmitter according to an embodiment.

FIG. 7 is a block diagram illustrating a structure of a wireless power receiver operatively connected with the wireless power transmitter according to the FIG. 6.

FIG. 8 is a diagram illustrating a method of modulation and demodulation of a wireless power signal according to an embodiment.

FIG. 9 illustrates a packet format according to an embodiment.

FIG. 10 illustrates the types of packets defined in the WPC (Qi) standard according to an embodiment.

FIGS. 11A to 11D illustrate message structures of an FOD status packet according to an embodiment of the present disclosure.

FIG. 12 is a flowchart illustrating an FOD detection method according to an embodiment.

FIG. 13 is a flowchart illustrating an FOD detection method according to another embodiment.

FIG. 14 is a flowchart illustrating an FOD detection method according to still another embodiment.

FIG. 15 shows a quality factor table according to an embodiment of the present disclosure.

FIG. 16 is a block diagram illustrating a configuration of an FO detection device according to an embodiment.

FIG. 17 is a flowchart illustrating an FOD detection method according to an embodiment.

FIG. 18 is a flowchart illustrating an FOD detection method according to another embodiment.

FIG. 19 is a block diagram illustrating a configuration of an FO detection device according to another embodiment.

### BEST MODE

A method of detecting a foreign object (FO) by a wireless power transmitter according to an embodiment includes receiving a second packet including a value of a second reference quality factor, determining a threshold using the value of the second reference quality factor, measuring a current quality factor value, and detecting the FO based on the threshold and the current quality factor value.

### Mode for Invention

Hereinafter, an apparatus and various methods to which embodiments of the present disclosure are applied will be described in detail with reference to the drawings. As used herein, the suffixes “module” and “unit” are added or used interchangeably to facilitate preparation of this specification and are not intended to suggest distinct meanings or functions.

In the description of the embodiments, it is to be understood that, when an element is described as being “on”/“over” or “beneath”/“under” another element, the two elements may directly contact each other or may be arranged with one or more intervening elements present therebetween. Also, the terms “on”/“over” or “beneath”/“under” may refer to not only an upward direction but also a downward direction with respect to one element.

For simplicity, in the description of the embodiments, “wireless power transmitter,” “wireless power transmission device,” “transmission end,” “transmitter,” “transmission device,” “transmission side,” “wireless power transfer device,” “wireless power transferer,” and the like will be used interchangeably to refer to a device equipped with a function of transmitting wireless power in a wireless charging system. In addition, “wireless power reception device,” “wireless power receiver,” “reception end,” “reception side,” “reception device,” “receiver,” and the like will be used interchangeably to refer to a device equipped with a function of receiving wireless power from a wireless power transmission device.

The transmitter according to the present disclosure may be configured as a pad type, a cradle type, an access point (AP) type, a small base station type, a stand type, a ceiling embedded type, a wall-mounted type, or the like. One transmitter may transmit power to a plurality of wireless power reception devices. To this end, the transmitter may include at least one wireless power transmission means. Here, the wireless power transmission means may employ various wireless power transmission standards which are based on the electromagnetic induction scheme for charging according to the electromagnetic induction principle meaning that a magnetic field is generated in a power transmission end coil and current is induced in a reception end coil by the magnetic field. Here, the wireless power transmission means may include wireless charging technology using electromagnetic induction schemes defined by the Wireless Power Consortium (WPC) and the Power Matters Alliance (PMA), which are wireless charging technology standard organizations.

In addition, a receiver according to an embodiment of the present disclosure may include at least one wireless power reception means, and may receive wireless power from two or more transmitters simultaneously. Here, the wireless power reception means may include wireless charging technologies of electromagnetic induction schemes defined by the Wireless Power Consortium (WPC) and the Power Matters Alliance (PMA), which are wireless charging technology standard organizations.

The receiver according to the present disclosure may be employed in small electronic devices including a mobile phone, a smartphone, a laptop computer, a digital broadcasting terminal, a PDA (Personal Digital Assistant), a PMP (Portable Multimedia Player), a navigation device, an electric toothbrush, an electronic tag, a lighting device, a remote control, a fishing float, and wearable devices such as a smart watch. However, the embodiments are not limited thereto. The applications may include any devices which are equipped with a wireless power transmission means and have a rechargeable battery.

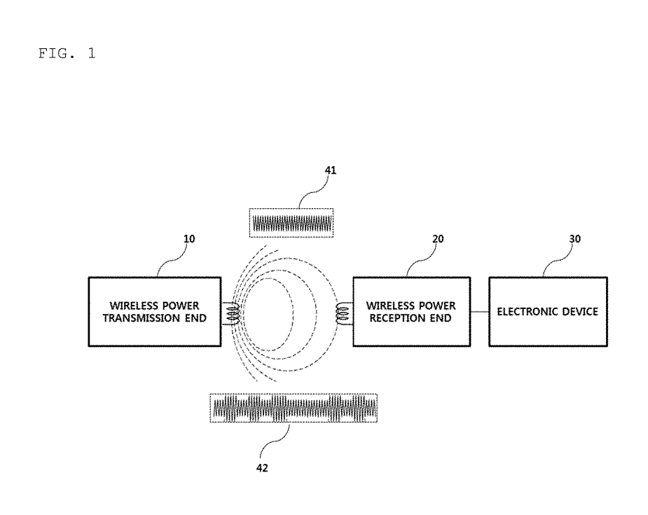

FIG. 1 is a block diagram illustrating a wireless charging system according to an embodiment.

Referring to FIG. 1, the wireless charging system may include a wireless power transmission end 10 configure to wirelessly transmit power, a wireless power reception end 20 configure to receive the transmitted power, and an electronic device 20 configured to be supplied with the received power.

In an example, the wireless power transmission end 10 and the wireless power reception end 20 may perform in-band communication, in which information is exchanged using the same frequency band as the operating frequency used for wireless power transmission. In another example, the wireless power transmission end 10 and the wireless power reception end 20 may perform out-of-band communication, in which information is exchanged using a separate frequency band different from the operating frequency used for wireless power transmission.

For example, the information exchanged between the wireless power transmission end 10 and the wireless power reception end 20 may include control information as well as state information about the terminals. Here, the state information and the control information exchanged between the transmission end and the reception end will be clarified through the embodiments which will be described later.

The in-band communication and the out-of-band communication may provide bidirectional communication, but embodiments are not limited thereto. In another embodiment, the in-band communication and the out-of-band communication may provide unidirectional communication or half-duplex communication.

For example, the unidirectional communication may be used for the wireless power reception end 20 to transmit information only to the wireless power transmission end 10, but embodiments are not limited thereto. The unidirectional communication may be used for the wireless power transmission end 10 to transmit information to the wireless power reception end 20.

In the half duplex communication, bidirectional communication may be performed between the wireless power reception end 20 and the wireless power transmission end 10, but only one device may be allowed to transmit information at a certain point of time.

The wireless power reception end 20 according to an embodiment may acquire various kinds of state information about an electronic device 30. For example, the state information about the electronic device 30 may include current power usage information, information for identifying an application being executed, CPU usage information, battery charging state information, and battery output voltage/current information, but embodiments are not limited thereto. The state information may include any information that may be acquired from the electronic device 30 and available for wireless power control.

In particular, the wireless power transmission end 10 according to an embodiment of the present disclosure may transmit, to the wireless power reception end 20, a predetermined packet indicating whether fast charging is supported. When it is determined that the connected wireless power transmission end 10 supports the fast charging mode, the wireless power reception end 20 may notify the electronic device 30 of the supportability. The electronic device 30 may indicate that fast charging is possible through a predetermined provided display means, for example, a liquid crystal display.

In addition, the user of the electronic device 30 may select a predetermined fast charging request button displayed on the liquid crystal display means to control the wireless power transmission end 10 to operate in the fast charging mode. In this case, when the fast charging request button is selected by the user, the electronic device 30 may transmit a predetermined fast charging request signal to the wireless power reception end 20. The wireless power reception end 20 may generate a charging mode packet corresponding to the received fast charging request signal and transmit the packet to the wireless power transmission end 10 so as to switch the general low power charging mode to the fast charging mode.

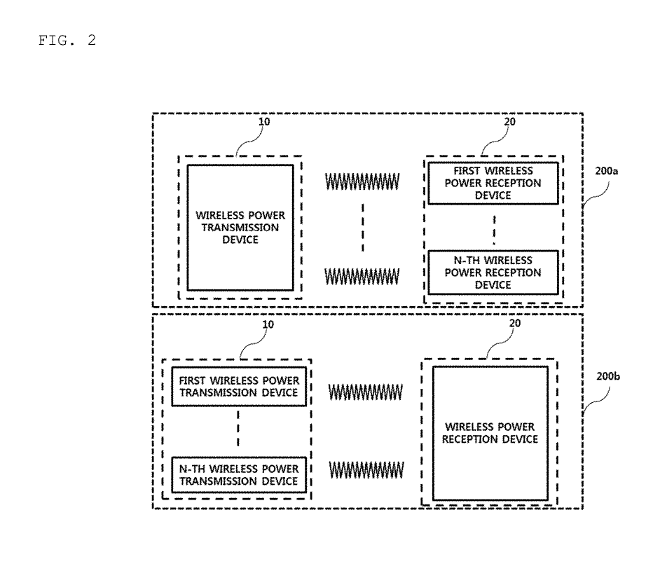

FIG. 2 is a block diagram illustrating a wireless charging system according to another embodiment.

For example, as indicated by reference numeral 200a, the wireless power reception end 20 may include a plurality of wireless power receiving devices, and a plurality of wireless power reception devices may be connected to one wireless power transmission end 10 to perform wireless charging. In this operation, the wireless power transmission end 10 may distribute and transmit power to a plurality of wireless power reception devices in a time division manner, but embodiments are not limited thereto. In another example, the wireless power transmission end 10 distribute and transmit power to a plurality of wireless power reception devices using different frequency bands allocated to the respective wireless power reception devices.

Here, the number of wireless power reception devices connectable to one wireless power transmission device 10 may be adaptively determined based on at least one of a required power for each wireless power reception device, a battery charging state, a power consumption amount of the electronic device, and an available power of the wireless power transmission device.

As another example, as indicated by reference numeral 200b, the wireless power transmission end 10 may include a plurality of wireless power transmission devices. In this case, the wireless power reception end 20 may be connected to a plurality of wireless power transmission devices simultaneously, and may receive power from the connected wireless power transmission devices simultaneously to perform charging. Here, the number of wireless power transmission devices connected to the wireless power reception end 20 may be adaptively determined based on a required power of the wireless power reception end 20, a battery charging state, a power consumption amount of the electronic device, an available power of the wireless power transmission device, and the like.

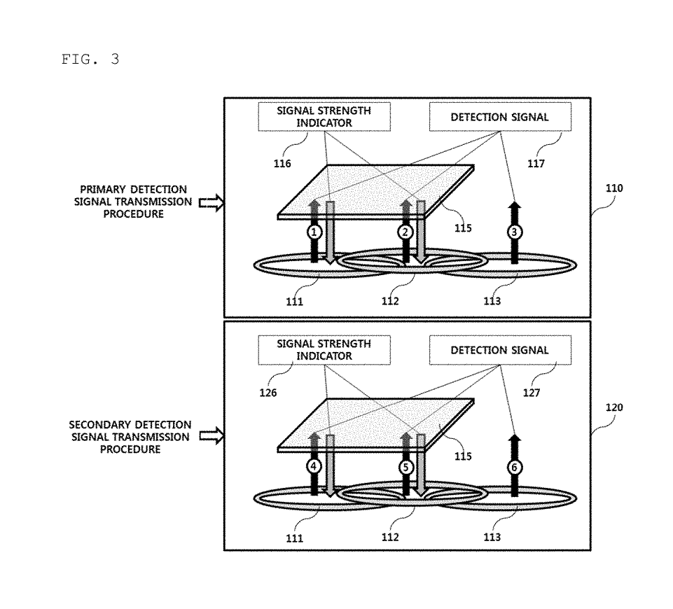

FIG. 3 is a diagram illustrating a procedure of transmitting a detection signal in a wireless charging system according to an embodiment.

As an example, the wireless power transmitter may be equipped with three transmission coils 111, 112, and 113. Each transmission coil may have a region partially overlapping the other transmission coils, and the wireless power transmitter sequentially transmits predetermined detection signals 117 and 127, for example, digital ping signals, for detecting presence of a wireless power receiver through the respective transmission coils in a predefined order.

As shown in FIG. 3, the wireless power transmitter may sequentially transmit detection signals 117 through a primary detection signal transmission procedure, which is indicated by reference numeral 110, and identify transmission coils 111 and 112 through which a signal strength indicator 116 is received from the wireless power receiver 115. Subsequently, the wireless power transmitter may sequentially transmit detection signals 127 through a secondary detection signal transmission procedure, which is indicated by reference numeral 120, identify a transmission coil exhibiting better power transmission efficiency (or charging efficiency), namely better alignment between the transmission coil and the reception coil, between the transmission coils 111 and 112 through which the signal strength indicator 126 is received, and perform a control operation to transmit power through the identified transmission coil, that is, to perform wireless charging.

The wireless power transmitter performs the detection signal transmission procedure twice as shown in FIG. 3 to more accurately identify a transmission coil that is better aligned with the reception coil of the wireless power receiver.

When the signal strength indicators 116 and 126 are received by the first transmission coil 111 and the second transmission coil 112 as indicated by reference numerals 110 and 120 of FIG. 3, the wireless power transmitter selects a transmission coil exhibiting the best alignment based on the signal strength indicator 126 received by each of the first transmission coil 111 and the second transmission coil 112 and performs wireless charging using the selected transmission coil.

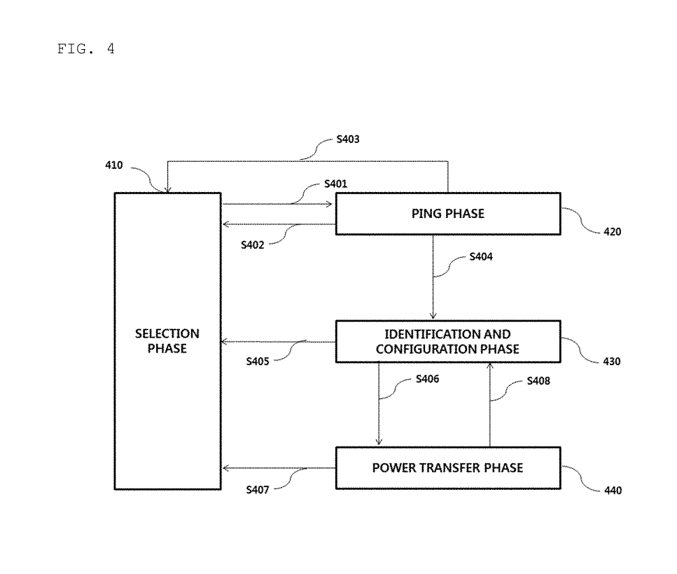

FIG. 4 is a state transition diagram illustrating a wireless power transmission procedure defined in the WPC standard.

Referring to FIG. 4, power transmission from a transmitter to a receiver according to the WPC standard is broadly divided into a selection phase 410, a ping phase 420, an identification and configuration phase 430, and a power transfer phase 440.

The selection phase 410 may be a phase which transitions when a specific error or a specific event is detected while power transmission begins or is maintained. Here, the specific error and the specific event will be clarified through the following description. Further, in the selection phase 410, the transmitter may monitor whether an object is present at the interface surface. When the transmitter detects an object being placed on the interface surface, it may transition to the ping phase 420 (S401). In the selection phase 410, the transmitter may transmit an analog ping signal of a very short pulse and detect whether an object is present in the active area of the interface surface based on the change in current of the transmission coils.

When the transmitter detects an object in the ping phase 420, it activates the receiver and transmits a digital ping to identify whether the receiver is a WPC standard-compatible receiver. In a case where the transmitter does not receive a response signal (e.g., a signal strength indicator) for the digital ping from the receiver in the ping phase 420, it may transition back to the selection phase 410 (S402). In addition, if the transmitter receives, from the receiver, a signal indicating completion of power transmission, that is, a charge completion signal in the ping phase 420, the transmitter may transition to the selection phase 410 (S403).

Once the ping phase 420 is complete, the transmitter may transition to the identification and configuration phase 430 for identifying the receiver and collecting configuration and state information about the receiver (S404).

In the identification and configuration phase 430, when an unexpected packet is received (unexpected packet), a desired packet is not received for a predefined time (timeout), there is an error in packet transmission (transmission error) or no power transfer contract is made (no power transfer contract), the transmitter may transition to the selection phase 410 (S405).

Once identification and configuration of the receiver are complete, the transmitter may transition to the power transfer phase for transmitting wireless power (S406).

In the power transfer phase 440, when an unexpected packet is received (unexpected packet), a desired packet is not received for a predefined time (timeout), a violation of a pre-established power transmission contract occurs (power transfer contract violation), and charging is complete, the transmitter may transition to the selection phase 410 (S407).

In addition, in the power transfer phase 440, when the power transfer contract needs to be reconfigured according to change in the state of the transmitter or the like, the transmitter may transition to the identification and configuration phase 430 (S408).

The above-mentioned power transmission contract may be set based on the state and characteristics information about the transmitter and the receiver. For example, the transmitter state information may include information on a maximum amount of transmittable power and information on a maximum number of acceptable receivers, and the receiver state information may include information on the required power.

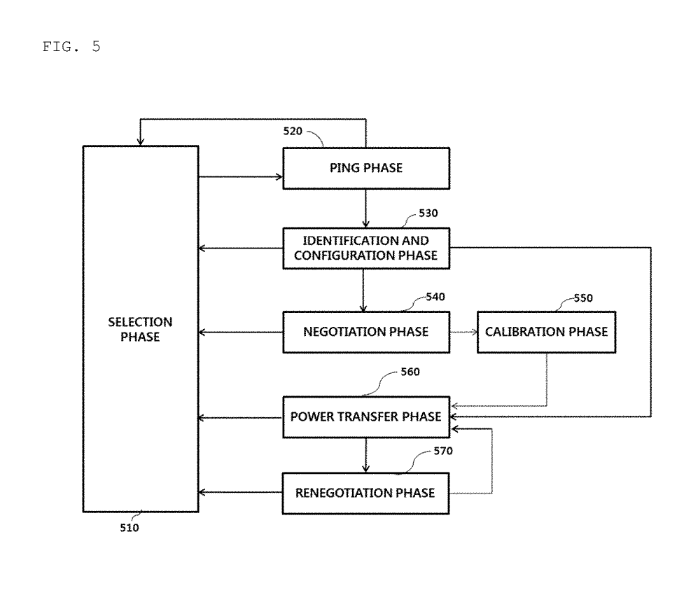

FIG. 5 is a state transition diagram illustrating a wireless power transmission procedure defined in the WPC (Qi) standard.

Referring to FIG. 5, power transmission from a transmitter to a receiver according to the WPC (Qi) standard may be broadly divided into a selection phase 510, a ping phase 520, an identification and configuration phase, 530, a negotiation phase 540, a calibration phase 550, a power transfer phase 560, and a renegotiation phase 560.

The selection phase 510 may be a phase which transitions to another phase (e.g., S502, S504, S506, S509), when a specific error or a specific event is detected while power transmission begins or is maintained. Here, the specific error and the specific event will be clarified through the following description. Further, in the selection phase 510, the transmitter may monitor whether an object is present at the interface surface. When the transmitter detects an object being placed on the interface surface, it may transition to the ping phase 520. In the selection phase 510, the transmitter may transmit an analog ping signal of a very short pulse and detect whether an object is present in the active area of the interface surface based on the change in current of the transmission coil or the primary coil.

When the transmitter detects an object in the ping phase 520, it activates the receiver and transmits a digital ping to identify whether the receiver is a WPC standard-compatible receiver. In a case where the transmitter does not receive a response signal (e.g., a signal strength packet) for the digital ping from the receiver in the ping phase 520, it may transition back to the selection phase 510. In addition, when the transmitter receives, from the receiver, a signal indicating completion of power transmission, that is, a charge completion packet in the ping phase 520, the transmitter may transition to the selection phase 510.

Once the ping phase 520 is complete, the transmitter may transition to the identification and configuration phase 530 for identifying the receiver and collecting configuration and state information about the receiver.

In the identification and configuration phase 530, when an unexpected packet is received (unexpected packet), a desired packet is not received for a predefined time (timeout), there is an error in packet transmission (transmission error) or no power transfer contract is made (no power transfer contract), the transmitter may transition to the selection phase 510.

The transmitter may check whether an entry to the negotiation phase 540 is necessary based on the value of the negotiation field in the configuration packet received in the identification and configuration phase 530.

When a negotiation is needed as a result of checking, the transmitter may enter negotiation phase 540 and perform a predetermined FOD procedure.

On the other hand, when a negotiation is not needed as a result of checking, the transmitter may immediately enter the power transfer phase 560.

In the negotiation phase 540, the transmitter may receive a foreign object detection (FOD) status packet including a value of a reference quality factor. Then, the transmitter may determine a threshold for FO detection based on the value of the reference quality factor.

Various methods for the transmitter to determine the threshold for FO detection based on the value of the reference quality factor will be described later in detail with reference to the drawings.

The transmitter may detect whether an FO is present in the charging area using the determined threshold and the currently measured quality factor value, and control power transmission according to the FO detection result.

In one example, when an FO is detected, the transmitter may return to the selection phase 510. On the other hand, when no FO is detected, the transmitter may enter the power transfer phase 560 via the calibration phase 550. Specifically, when no FO is detected, the transmitter may determine, in the calibration phase 550, the intensity of power received by the reception end, and measure power loss at the reception end and the transmission end to determine the intensity of power transmitted from the transmission end. That is, in the calibration phase 550, the transmitter may predict power loss based on the difference between the transmitted power of the transmission end and the received power of the reception end. According to an embodiment, the transmitter may calibrate the threshold for FOD in consideration of the predicted power loss.

In the power transfer phase 540, when an unexpected packet is received (unexpected packet), a desired packet is not received for a predefined time (timeout), a violation of a pre-established power transmission contract occurs (power transfer contract violation), and charging is complete, the transmitter may transition to the selection phase 510.

In addition, in the power transfer phase 440, when the power transfer contract needs to be reconfigured according to change in the state of the transmitter or the like, the transmitter may transition to the renegotiation phase 570. In this case, when the renegotiation is normally completed, the transmitter may return to the power transfer phase 560.

The above-mentioned power transmission contract may be set based on the state and characteristics information about the transmitter and the receiver. For example, the transmitter state information may include information on a maximum amount of transmittable power and information on a maximum number of acceptable receivers, and the receiver state information may include information on the required power.

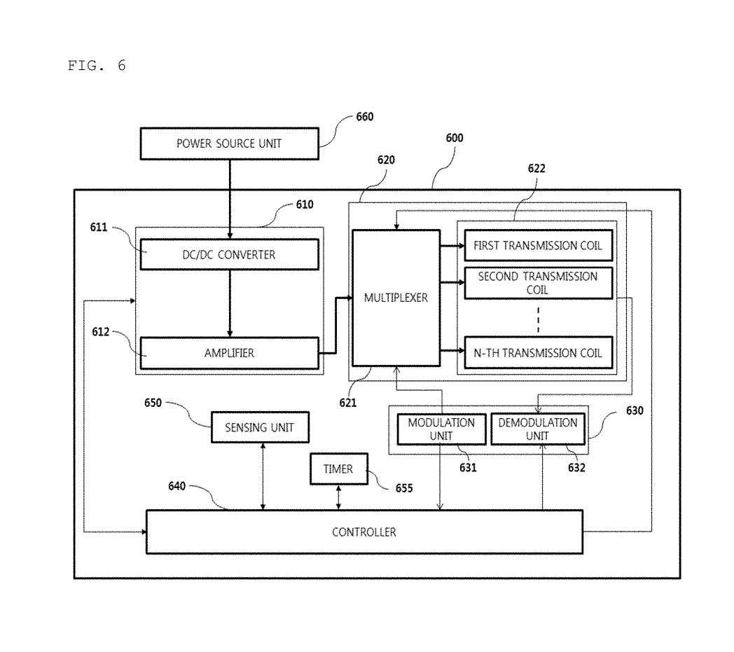

FIG. 6 is a block diagram illustrating a structure of a wireless power transmitter according to an embodiment.

Referring to FIG. 6, the wireless power transmitter 600 may include a power conversion unit 610, a power transmission unit 620, a communication unit 630, a controller 640, and a sensing unit 650. It should be noted that the elements of the wireless power transmitter 600 described above are not necessarily essential elements, and thus the wireless power transmitter may be configured to include more or fewer elements.

As shown in FIG. 6, when power is supplied from a power source unit 660, the power conversion unit 610 may function to convert the power into power having a predetermined intensity.

To this end, the power conversion unit 610 may include a DC/DC converter 611, and an amplifier 612.

The DC/DC converter 611 may function to convert DC power supplied from the power source unit 650 into DC power having a specific intensity according to a control signal of the controller 640.

Then, the sensing unit 650 may measure the voltage/current of the DC-converted power and provide the measured voltage/current to the controller 640. In addition, the sensing unit 650 may measure the internal temperature of the wireless power transmitter 600 and provide the measurement result to the controller 640 in order to determine whether overheating occurs. For example, the control unit 640 may adaptively cut off power supplied from the power source unit 650 or cut off power supplied to the amplifier 612, based on the voltage/current value measured by the sensing unit 650. To this end, a predetermined power cutoff circuit may be further provided on one side of the power conversion unit 610 to cut off power supplied from the power source unit 650 or to cut off power supplied to the amplifier 612.

The amplifier 612 may adjust the intensity of the DC/DC-converted power according to a control signal of the controller 640. For example, the control unit 640 may receive power reception state information about the wireless power receiver and/or a power control signal through the communication unit 630 and may dynamically adjust the amplification factor of the amplifier 612 based on the received power reception state information and/or power control signal. For example, the power reception state information may include, but is not limited to, intensity information about the rectifier output voltage and intensity information about the current applied to the reception coil. The power control signal may include a signal for requesting increase of power and a signal for requesting decrease of power.

The power transmission unit 620 may include a multiplexer 621 and a transmitting coil 622. The power transmission unit 620 may further include a carrier generator (not shown) configured to generate a specific operating frequency for power transmission.

The carrier generator may generate a specific frequency for converting the output DC power of the amplifier 612 received through the multiplexer 621 to AC power having a specific frequency. While it has been described that the AC signal generated by the carrier generator is mixed at the output end of the multiplexer 621 to generate AC power, this is merely one embodiment. In another example, it is to be noted that the generated signal may be mixed at a stage before or after the amplifier 612.

It should be noted that the frequencies of the AC power delivered to the respective transmission coils according to an embodiment may be different from each other. In another embodiment of the present disclosure, the resonance frequency may be set differently for each transmission coil using a predetermined frequency controller having a function of adjusting the LC resonance characteristics differently for the respective transmission coils.

As shown in FIG. 6, the power transmission unit 620 may include a multiplexer 621 for controlling transmission of the output power of the amplifier 612 to transmission coils, and a plurality of transmission coils 622, i.e., first to n-th transmission coils.

When a plurality of wireless power receivers are connected, the controller 640 according to an embodiment of the present disclosure may transmit power by time division multiplexing for each transmission coil. For example, when three wireless power receivers, i.e., first to third wireless power receivers, are each identified through three different transmission coils, i.e., first to third transmission coils, in the wireless power transmitter 600, the controller 640 may control the multiplexer 621 such that power may be transmitted through a specific transmission coil in a specific time slot. Here, the amount of power to be transmitted to the corresponding wireless power receiver may be controlled according to the length of the time slot allocated to each transmission coil, but this is merely one embodiment. In another embodiment, the amplification factor of the amplifier 612 may be controlled during the time slot allocated to each transmission coil to control the transmit power for each wireless power receiver.

The controller 640 may control the multiplexer 621 so as to sequentially transmit the detection signals through the first to n-th transmission coils 622 during the primary detection signal transmission procedure. In this case, the controller 640 may identify, through the timer 655, a time to transmit a detection signal. When the time reaches the detection signal transmission time comes, the controller 640 may control the multiplexer 621 to transmit the detection signals through the corresponding transmission coils. For example, the timer 650 may transmit a specific event signal to the controller 640 at predetermined intervals during the ping transmission phase. When the event signal is detected, the controller 640 may control the multiplexer 621 so as to transmit the digital ping through the corresponding transmission coil.

In addition, during the primary detection signal transmission procedure, the controller 640 may receive a predetermined transmission coil identifier for identifying a transmission coil through which a signal strength indicator has been received from the demodulation unit 632 and the signal strength indicator received through the corresponding transmission coil. Subsequently, in the secondary detection signal transmission procedure, the controller 640 may control the multiplexer 621 such that the detection signal may be transmitted only through the transmission coil(s) through which the signal strength indicator has been received during the primary detection signal transmission procedure. In another example, when there is a plurality of transmission coils through which the signal strength indicators have been received during the first differential detection signal transmission procedure, the controller 640 may determine a transmission coil through which a signal strength indicator having the greatest value has been received as a transmission coil to be used first to transmit a detection signal in the secondary detection signal transmission procedure, and control the multiplexer 621 according to the result of the determination.

The modulation unit 631 may modulate the control signal generated by the controller 640 and transfer the modulated control signal to the multiplexer 621. Here, the modulation schemes for modulating the control signal may include, but is not limited to, frequency shift keying (FSK), Manchester coding, phase shift keying (PSK), pulse width modulation, and differential bi-phase modulation.

When a signal received through a transmission coil is detected, the demodulation unit 632 may demodulate the detected signal and transmit the demodulated signal to the controller 640. Here, the demodulated signal may include a signal strength indicator, an error correction (EC) indicator for power control during wireless power transmission, an EOC (end of charge) indicator, and an overvoltage/overcurrent/overheat indicator, but embodiments are not limited thereto. The demodulated signal may include various kinds of state information for identifying the state of the wireless power receiver.

In addition, the demodulation unit 632 may identify a transmission coil through which the demodulated signal has been received, and provide the controller 640 with a predetermined transmit coil identifier corresponding to the identified transmission coil.

The demodulation unit 632 may also demodulate the signal received through the transmission coil 623 and transmit the demodulated signal to the controller 640. In one example, the demodulated signal may include, but is not limited to, a signal strength indicator. The demodulated signal may include various kinds of state information about the wireless power receiver.

In one example, the wireless power transmitter 600 may acquire the signal strength indicator through in-band communication that uses the same frequency as used for wireless power transmission to communicate with the wireless power receiver.

In addition, the wireless power transmitter 600 may not only transmit wireless power using the transmission coil 622, but also exchange various kinds of information with the wireless power receiver through the transmission coil 622. In another example, it should be noted that the wireless power transmitter 600 may further include separate coils corresponding to each of the transmission coils 622, i.e., the first to n-th transmission coils, and perform in-band communications with the wireless power receiver using the separate coils.

Although FIG. 6 illustrates that the wireless power transmitter 600 and the wireless power receiver perform in-band communication, this is merely an example. The transmitter and the receiver may perform short-range bidirectional communication through a frequency band different from the frequency band used for transmission of wireless power signals. For example, the short-range bidirectional communication may be any one of low-power Bluetooth communication, RFID communication, UWB communication, and ZigBee communication.

In particular, the wireless power transmitter 600 according to an embodiment of the present disclosure may adaptively provide a fast charging mode and a general low power charging mode at the request from the wireless power receiver.

When the fast charging mode is supportable, the wireless power transmitter 600 may transmit a signal of a predetermined pattern (hereinafter referred to as a first packet for simplicity). Upon receiving a first packet, the wireless power receiver 600 may identify that the wireless power transmitter 600 connected to the receiver is capable of performing fast charging.

In particular, the wireless power receiver needs fast charging, it may transmit, to the wireless power transmitter 600, a first response packet for requesting fast charging.

In particular, when a predetermined time passes after the first response packet is received, the wireless power transmitter 600 may automatically switch to the fast charging mode and initiate fast charging.

For example, when the controller 640 of the wireless power transmitter 600 transitions to the power transfer phase 440 or 540 of FIG. 4 or 5, the controller 640 may controls the first packet to be transmitted through the transmission coil 622, but this is merely an example. In another example, the first packet may be transmitted in the identification and configuration phase 430 of FIG. 4 or the identification phase 530 of FIG. 5.

According to another embodiment of the present disclosure, it should be noted that, information for identifying whether or not fast charging is supportable may be encoded in and transmitted over the digital ping signal transmitted by the wireless power transmitter 600.

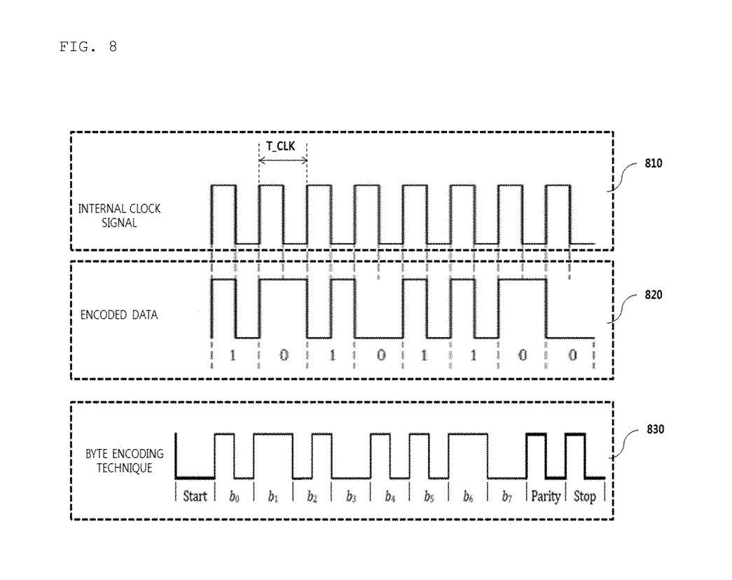

When fast charging is needed at any point in time in the power transfer phase, the wireless power receiver may transmit, to the wireless power transmitter 600, a predetermined charging mode packet in which the charging mode is set to fast charging. Details of the configuration of the charging mode packet will be more clearly understood from the description given later with reference to FIGS. 8 to 12. Of course, when the charging mode is changed to the fast charging mode, the wireless power transmitter 600 and the wireless power receiver may control internal operations to allow transmission and reception of power corresponding to the fast charging mode. For example, when the charging mode is changed from the general low-power charging mode to the fast charging mode, a reference value for determination of overvoltage, a reference value for determination of over-temperature, a reference value for determination of low voltage/high voltage, an optimum voltage level, a power control offset, and the like may be changed and set.

For example, when the charging mode is changed from the general low-power charging mode to the fast charging mode, a threshold voltage for determining overvoltage may be set to be high enough to allow fast charging. As another example, a threshold temperature for determining whether overheating occurs may be set high considering the temperature rise according to fast charging. As another example, the power control offset value, which means the minimum level at which the power is controlled at the transmission end, may be set to a value greater than a value set in the general low-power charging mode such that the value can quickly converge to a desired target power level in the fast charging mode.

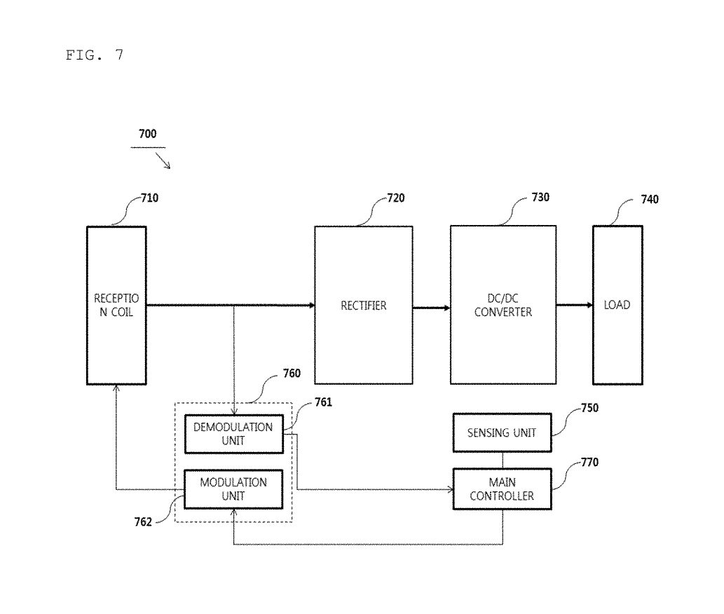

FIG. 7 is a block diagram illustrating a structure of a wireless power receiver operatively connected with the wireless power transmitter according to the FIG. 6.

Referring to FIG. 7, the wireless power receiver 700 may include a reception coil 710, a rectifier 720, a DC/DC converter 730, a load 740, a sensing unit 750, a communication unit 760, and a main controller 770. Here, the communication unit 760 may include a demodulation unit 761 and a modulation unit 762.

Although the wireless power receiver 700 is illustrated in FIG. 7 as being capable of exchanging information with the wireless power transmitter 600 through in-band communication, this is merely an embodiment. According to another embodiment of the present disclosure, the communication unit 760 may provide short-range bidirectional communication through a frequency band different from the frequency band used for transmission of wireless power signals.

The AC power received via the reception coil 710 may be transferred to the rectifier 720. The rectifier 720 may convert the AC power to DC power and transmit the DC power to the DC/DC converter 730. The DC/DC converter 730 may convert the intensity of the rectifier output DC power to a specific intensity required by the load 740 and then deliver the converted power to the load 740.

The sensing unit 750 may measure the intensity of the DC power output from the rectifier 720 and may provide the measured DC power to the main controller 770. In addition, the sensing unit 750 may measure the intensity of the current applied to the reception coil 710 according to the wireless power reception, and may transmit the measurement result to the main controller 770. Further, the sensing unit 750 may measure the internal temperature of the wireless power receiver 700 and provide the measured temperature to the main controller 770.

For example, the main controller 770 may compare the intensity of the measured rectifier output DC power with a predetermined reference value to determine whether an overvoltage is generated. When an overvoltage has been generated as a result of the determination, the main controller may generate a predetermined packet indicating that an overvoltage has occurred and transmit the packet to the modulation unit 762. Here, the signal modulated by the modulation unit 762 may be transmitted to the wireless power transmitter 600 through the reception coil 710 or a separate coil (not shown). Further, when the intensity of the rectifier output DC power is greater than or equal to a predetermined reference value, the main controller 770 may determine that the detection signal has been received. When the detection signal is received, the main controller may control the signal strength indicator corresponding to the detection signal to be transmitted to the wireless power transmitter 600 through the demodulation unit 762. In another example, the demodulation unit 761 may demodulate an AC power signal between the reception coil 710 and the rectifier 720 or a DC power signal output from the rectifier 720 to identify whether or not the detection signal has been received, and then provide the result of the identification to the main controller 770. Then, the main controller 770 may control a signal strength indicator corresponding to the detection signal to be transmitted through the modulation unit 761.

In particular, according to an embodiment of the present disclosure, the main controller 770 may determine whether the connected wireless power transmitter is a wireless power transmitter capable of performing fast charging, based on the information demodulated by the demodulation unit 760.

In addition, when a predetermined fast charging request signal for requesting fast charging is received from the electronic device 30 of FIG. 1, the main controller 770 may generate a charging mode packet corresponding to the received fast charging request signal and transmit the packet to the demodulation unit 761. Here, the fast charging request signal from the electronic device may be received according to selection of a user menu on a predetermined user interface.

According to another embodiment of the present disclosure, when it is determined that the connected wireless power transmitter supports the fast charging mode, the main controller 770 may automatically request the wireless power transmitter to perform fast charging based on the remaining amount or battery charge or control the wireless power transmitter to stop fast charging and switch to the general low-power charging mode.

According to another embodiment, the main controller 770 may monitor power consumption of the electric device in real time during charging in the general low-power charging mode. When consumed power of the electronic device is greater than or equal to a predetermined reference value, the main controller 770 may generate a predetermined charging mode packet for requesting switch to the fast charging mode and transmit the packet to the modulation unit 761.

According to another embodiment of the present disclosure, the main controller 770 may determine whether overheating has occurred by comparing the internal temperature measured by the sensing unit 750 with a predetermined reference value. When overheating occurs during fast charging, the main controller 770 may generate and transmit a charging mode packet such that the wireless power transmitter switches to the general low-power charging mode.

According to still another embodiment of the present disclosure, the main controller 770 may determine whether the charging mode needs to be changed based on at least one of the battery charging rate, the internal temperature, the intensity of the rectifier output voltage, the usage rate of a CPU mounted on the electronic device, and the user menu selection, and generate a charging mode packet including the value of a charging mode for the wireless power transmitter to switch to and transmit the generated charging mode packet to the wireless power transmitter.

FIG. 8 is a diagram illustrating a method of modulation and demodulation of a wireless power signal according to an embodiment.

As shown in a section indicated by reference numeral 810 in FIG. 8, the wireless power transmission end 10 and the wireless power reception end 20 may encode or decode a packet to be transmitted based on an internal clock signal having the same periodicity.

Hereinafter, a method of encoding a packet to be transmitted will be described in detail with reference to FIGS. 1 to 8.

Referring to FIG. 1, when the wireless power transmission end 10 or the wireless power reception end 20 does not transmit a specific packet, the wireless power signal may be an alternating current signal of a specific frequency that is not modulated, as shown in the section indicated by reference numeral 41 in FIG. 1. On the other hand, when the wireless power transmission end 10 or the wireless power reception end 20 transmits the specific packet, the wireless power signal may be an AC signal modulated in a specific modulation scheme, as shown in the section indicated by reference numeral 42 in FIG. 1. For example, the modulation scheme may include, but is not limited to, an amplitude modulation scheme, a frequency modulation scheme, a frequency and amplitude modulation scheme, and a phase modulation scheme.

The binary data of the packet generated by the wireless power transmission end 10 or the wireless power reception end 20 may be subjected to differential bi-phase encoding as shown in the section indicated by reference numeral 820. Specifically, the differential bi-stage encoding undergoes two state transitions to encode data bit 1 and undergoes one state transition to encode data bit 0. That is, the data bit 1 may be encoded such that transition between state HI and state LO occurs at the rising edge and the falling edge of the clock signal, and data bit 0 may be encoded such that transition between state HI and state LO occurs at HI at the rising edge of the clock signal.

A byte encoding technique may be applied to the encoded binary data, as shown in the section indicated by reference numeral 830. Referring to the section indicated by reference numeral 830, a byte encoding technique according to an embodiment of the present disclosure may be a technique of inserting a start bit and a stop bit for identifying start and stop of a 8-bit encoded binary bitstream and a parity bit for detecting whether an error has occurred in the bitstream (in byte).

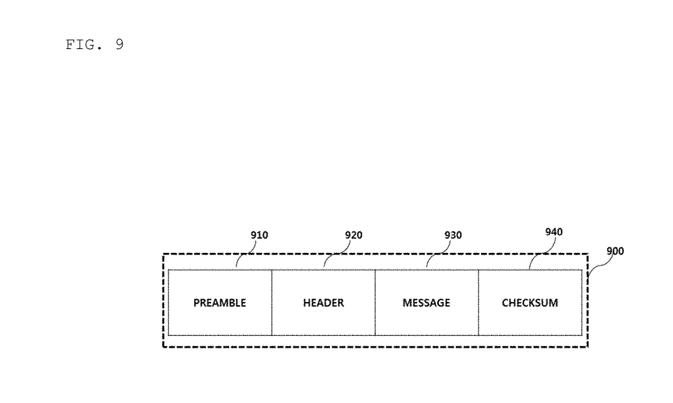

FIG. 9 illustrates a packet format according to an embodiment.

Referring to FIG. 9, a packet format 900 used for information exchange between the wireless power transmission end 10 and the wireless power reception end 20 may include a preamble field 910 for acquiring synchronization for demodulation of the packet and identifying an accurate start bit of the packet, a header field 920 for identifying the type of a message included in the packet, a message field 930 for transmitting the content of the packet (or a payload), and a checksum (940) field for identifying whether an error has occurred in the packet.

As shown in FIG. 9, the packet reception end may identify the size of the message 930 included in the packet based on the value of the header 920.

In addition, the header 920 may be defined for each phase of the wireless power transmission procedure. The same value of the header 920 may be defined in different phases. For example, referring to FIG. 9, it should be noted that the header value corresponding to the End Power Transfer in the ping phase and the header value corresponding to the End Power Transfer in the power transfer phase may all be 0x02.

The message 930 includes data to be transmitted at the transmitting end of the packet. For example, the data contained in the message field 930 may be, but is not limited to, a report, a request, or a response to the other party.

According to another embodiment of the present disclosure, the packet 900 may further include at least one of transmission end identification information for identifying a transmission end that transmits the packet and reception end identifying information for identifying a reception end to receive the packet. Here, the transmission end identification information and the reception end identification information may include, but is not limited to, IP address information, MAC address information, and product identification information, and the like. They may include any information for distinguishing between the reception end and the transmission end in the wireless charging system.

According to still another embodiment of the present disclosure, the packet 900 may further include predetermined group identification information for identifying a reception group when the packet is to be received by a plurality of devices.

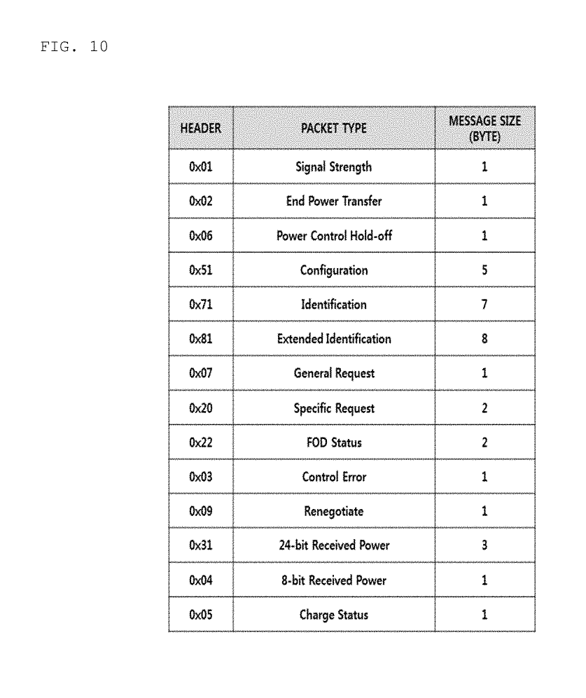

FIG. 10 illustrates the types of packets transmitted from a wireless power receiver to a wireless power transmitter according to an embodiment of the present disclosure.

Referring to FIG. 10, packets transmitted from a wireless power receiver to a wireless power transmitter may include a signal strength packet for transmitting strength information about a detected ping signal, an end power transfer packet for requesting the transmission end to stop power transmission, a power control hold-off packet for transmitting time for waiting until power is actually adjusted after receiving a control error packet for control, a configuration packet for transmitting the configuration information about the receiver, an identification packet and an extended identification packet for transmitting identification information about the receiver, a general request packet for transmitting a general request message, a specific request packet for transmitting a specific request message, an FOD status packet for transmitting a reference quality factor value for FO detection, a control error packet for controlling the transmission power of the transmitter, a renegotiation packet for starting renegotiation, a 24-bit received power packet and an 8-bit received power packet for transmitting intensity information about the received power, and a charge status packet for transmitting charge status information about a current load.

The packets to be transmitted from the wireless power receiver to the wireless power transmitter may be transmitted through in-band communication using the same frequency band as that used for wireless power transmission.

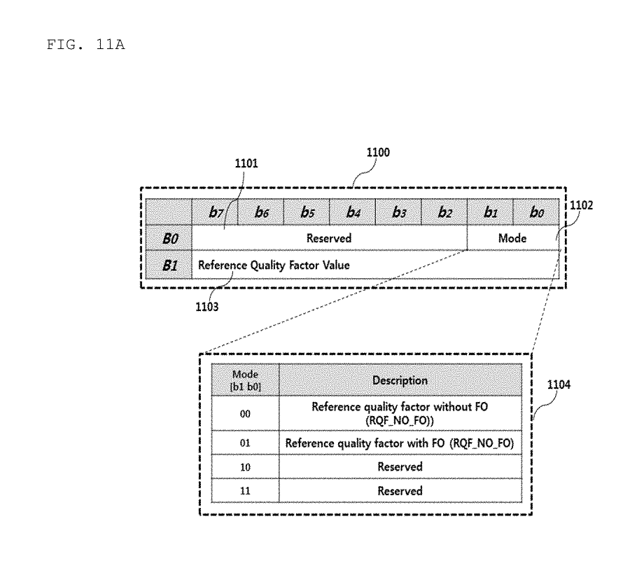

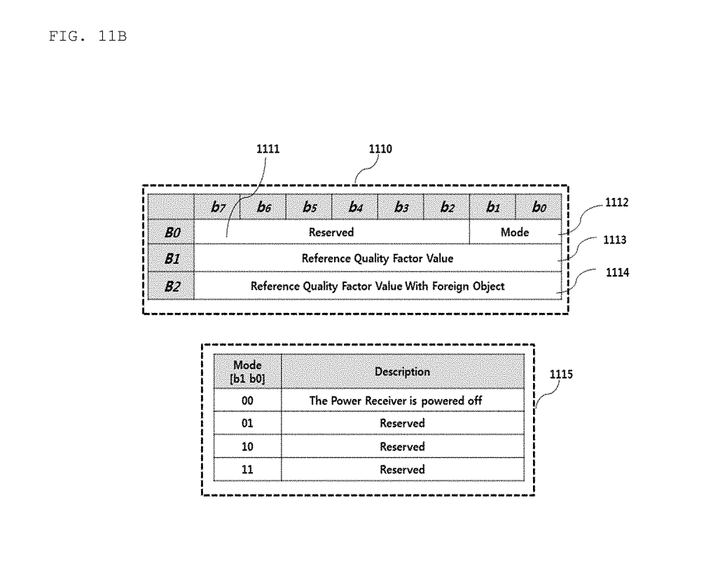

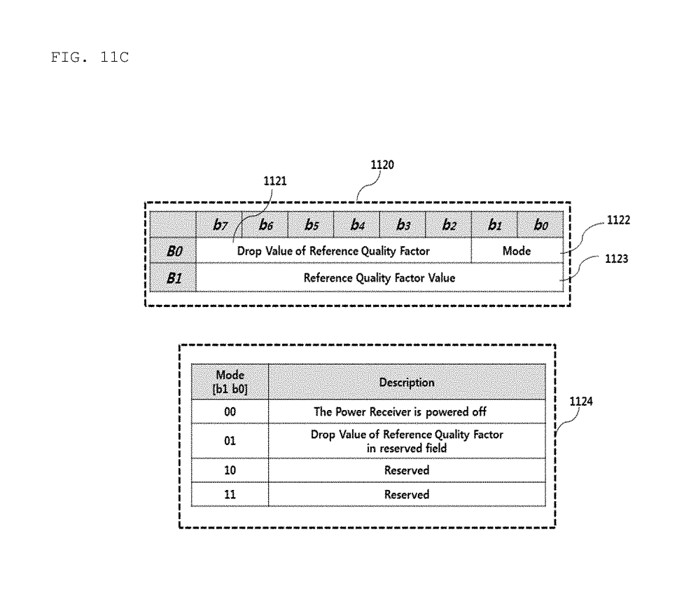

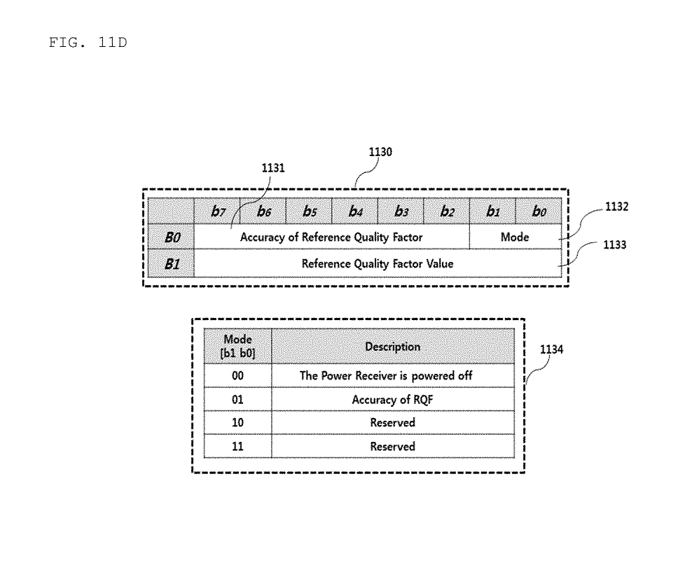

FIG. 11A illustrates a message structure of an FOD status packet according to an embodiment of the present disclosure.

Referring to FIG. 11A, an FOD status packet message 1100 may have a length of 2 bytes and may include a 6-bit reserved field 1101, a 2-bit mode field 1102, and a 1-byte field of reference quality factor value 1103.

All bits constituting the reserved field 1101 may be set to 0.

Referring to the section indicated by reference numeral 1104, when the value of the mode field 1102 is a binary number ‘00’, it may indicate that the value of a reference quality factor (first reference quality factor) RQF_NO_FO has been recorded in the reference quality factor value field 1103 in the absence of an FO. When the mode field 1102 is set to a binary number ‘01’, it may indicate that the value of a reference quality factor (second reference quality factor) RQF_FO has been recorded in the reference quality factor value field 1103 in the presence of an FO.

FIG. 11B illustrates a message structure of an FO status packet according to another embodiment of the present disclosure.

Referring to FIG. 11B, an FO status packet message 1110 may have a length of 3 bytes and may include a 6-bit reserved field 1111, a 2-bit mode field 1112, a reference quality factor value 1113, and a reference quality factor value with foreign object 1114.

All bits constituting the reserved field 1101 may be set to 0.

The operation mode of a power receiver to which the reference quality factor value 1113 is applied may be identified through the mode field 1112. Referring to the section indicated by reference numeral 1115, when the value of the mode 1112 is a binary number ‘00’, it indicates that the reference quality factor value is a value measured with the wireless power receiver set in the OFF state.

The reference quality factor value measured in the absence of a foreign object and the reference quality factor value measured in the presence of a foreign object may differ among the manufacturers and/or product types of the wireless power receiver.

According to an embodiment of the present disclosure, the wireless power transmitter may adaptively determine a quality factor threshold for determining whether a foreign object is present in consideration of a reference quality factor value measured in the absence of a foreign object and a reference quality factor value measured in the presence of a foreign object. This is because the amount of change in the quality factor value due to presence of a foreign object may vary among receivers. Accordingly, the present disclosure may minimize the heat generation or remarkable degradation of power transmission efficiency that occur when a foreign object is not normally detected even though the foreign object is located in the charging area.

FIG. 11C illustrates a message structure of an FO status packet according to still another embodiment of the present disclosure.

Referring to FIG. 11C, an FO status packet message 1120 may have a length of 2 bytes and include a 6-bit field of Drop Value of Reference Quality Factor 1121, a 2-bit mode field 1122, and a reference quality factor value field 1123.

Here, the Drop Value of Reference Quality Factor 1121 may have a value determined based on a reference quality factor value 1223 measured in the absence of an foreign object and a quality factor value with foreign object measured in the presence of a specific foreign object.

The mode field 1122 may be used to indicate that a drop value of reference quality factor 1121 has been recorded in the reserved field 1101 of FIG. 11A. For example, referring to the section indicated by reference numeral 1124, when the value of the mode field 1122 is a binary number ‘01’, it may indicate that a drop value of reference quality factor 1121 has been recorded in the reserved field, but this is merely an embodiment. Another value of the mode field 1122, e.g., a binary number ‘10’ or a binary number ‘11’, may be used to indicate that a drop value of reference quality factor 1121 has been recorded in the reserved field.

However, when the mode field 1122 is set to a value other than the binary number ‘00’, it may automatically imply that the reference quality factor value 1123 is a value measured with the power receiver set in the OFF state.

For simplicity, the formats of a foreign object status packet has been distinguishably described according to the mode as a specific embodiment. However, the foreign matter status packet may take the form of the embodiments of FIGS. 11A to 11D regardless of the mode.

Hereinafter, for simplicity, a reference quality factor value 1223 measured in the absence of a foreign object is referred to as RQF_NO_FO, and a quality factor value measured in the presence of a specific foreign object is referred to as QF_FO. Here, as the specific foreign object, any one of the foreign objects defined in the WPC Qi standard may be used. For example, the specific foreign object may be Foreign Object #4, which is an aluminum disk having a diameter of 22 mm and a thickness of 1 mm, but is not limited thereto. As the specific foreign object, any one of ordinary commercial coins may be used.

For example, the drop value of reference quality factor 1121 may be determined as a value obtained by subtracting the quality factor value measured in the presence of a specific foreign object from the reference quality factor value 1223 corresponding to the wireless power receiver.

In another example, the drop value of reference quality factor 1121 may be a drop ratio of the quality factor value measured in the presence of a foreign object to the reference quality factor value 1223 measured in the absence of a foreign object. In this case, the drop value of reference quality factor 1121 may be calculated as a percentage (%) or be an integer value calculated by dividing the percentage by a specific unit value (STEP_VALUE). However, embodiments are not limited thereto. For example, the drop value of reference quality factor 1121 may be calculated by Equation 1 below.

[(RQF_NO_FO−QF_FO)/RQF_NO_FO]*100 or

[((RQF_NO_FO−QF_FO)/RQF_NO_FO)*100]/STEP_VALUE Equation 1

(Here, *100 is for indication in % and the actual value may be a value that does not reflect *100).

The wireless power receiver may have a different drop value of reference quality factor depending on the manufacturer and/or product type thereof.

Therefore, the wireless power transmitter according to an embodiment of the present disclosure may acquire the drop value of reference quality factor from the detected wireless power receiver and adaptively determine the quality factor threshold for determining presence or absence of the foreign object in consideration of the drop value of the reference quality factor.

Accordingly, the present disclosure may minimize the heat generation or remarkable degradation of power transmission efficiency that occur when a foreign object is not normally detected even though the foreign object is located in the charging area.

FIG. 11D illustrates a message structure of an FO status packet according to yet another embodiment of the present disclosure.

Referring to FIG. 11D, an FO status packet message 1130 may have a length of 2 bytes, and include a 6-bit Accuracy of Reference Quality Factor field 1131, a 2-bit mode field 1132, and a reference quality factor value field 1133.

Here, the accuracy of reference quality factor 1131 may be an error tolerance with respect to a reference quality factor value 1223 measured in the absence of an foreign object. For example, the reference quality factor value to which the error tolerance is applied may be set to a ratio that is increased or decreased with respect to the reference quality factor value 1223 received from the wireless power reception device, but is not limited thereto.

The accuracy of reference quality factor 1131 may have a different value depending on the manufacturer and/or product type of the wireless power receiver. For example, the wireless power receiver of manufacturer A and the wireless power receiver of manufacturer B may have different accuracies of the reference quality factor values measured in operative connection with the same wireless power transmitter. Therefore, the wireless power transmitter needs to acquire information about the accuracy of the reference quality factor for each wireless power receiver, and may determine the quality factor threshold for determining presence or absence of a foreign object in consideration of the accuracy of the reference quality factor. Hereinafter, for simplicity, the quality factor threshold for determining presence or absence of a foreign object is referred to as FO_QF_THRESHOLD.

For example, as a result of testing for the same wireless power transmitter, the reference quality factor value measured for the wireless power receiver of manufacturer A may be 100, and the reference quality factor value measured for the wireless power receiver of manufacturer B may be 70. In this case, the accuracy of reference quality factor, e.g., +/−7%, corresponding to the wireless power receiver of manufacturer B may be set to be higher than the accuracy of reference quality factor, e.g., +/−10%, corresponding to the wireless power receiver of manufacturer A. That is, the sensitivity to the error may be set higher for the wireless power receiver of manufacturer B than for the wireless power receiver of manufacturer A.

As such, the quality factor accuracy may vary depending on the configuration of the finished product on which the receiver is installed. For example, depending on the PCB, camera module, antenna and other parts mounted on a finished product, the quality factor may be measured lower than in other finished products even in the absence of foreign objects. Accordingly, the finished product placed in the charging area together with a foreign object may have a smaller difference in quality factor value than the other finished products, and thus require higher measurement accuracy.

The mode field 1132 may be used to indicate that the accuracy of reference quality factor 1131 is recorded in the reserved field 1101 of FIG. 11A. For example, referring to the section indicated by reference numeral 1134, when the value of the mode field 1132 is a binary number ‘01’, it may indicate that the accuracy of reference quality factor 1131 is recorded in the reserved field, but this is merely an embodiment. Another value of the mode field 1132, e.g., a binary number ‘10’ or a binary number ‘11’, may be used to indicate that the accuracy of reference quality factor 1131 is recorded in the reserved field.

However, when the mode field 1132 is set to a value other than the binary number ‘00’, it may automatically imply that the reference quality factor value 1133 is a value measured with the power receiver set in the OFF state.

In the foreign object detection method defined in the conventional WPC Qi standard, the current quality factor value is measured before the wireless power transmitter performs the ping phase, that is, the selection phase. The wireless power transmitter determines a quality factor threshold for determining presence or absence of a foreign object in consideration of the reference quality factor value received from the wireless power receiver in the negotiation phase, a production and measurement tolerance for taking into account the difference in design between the transmitters, and the accuracy of reference quality factor.

The reference quality factor value means the least value among the quality factor values measured in five regions (the middle position and four positions shifted left, right, up and down by 5 mm) of the charging area of a test power transmitter (TPT), for example, a transmitter of the MP1 type defined in the WPC Qi standard. Depending on the difference in design between the test power transmitter MP1 and a commercial wireless power transmitter, including, for example, the inductance value of the transmission coil, the quality factor value actually measured in the charging area may vary from one transmitter to another. The tolerance for calibrating the difference is called a production and measurement tolerance.

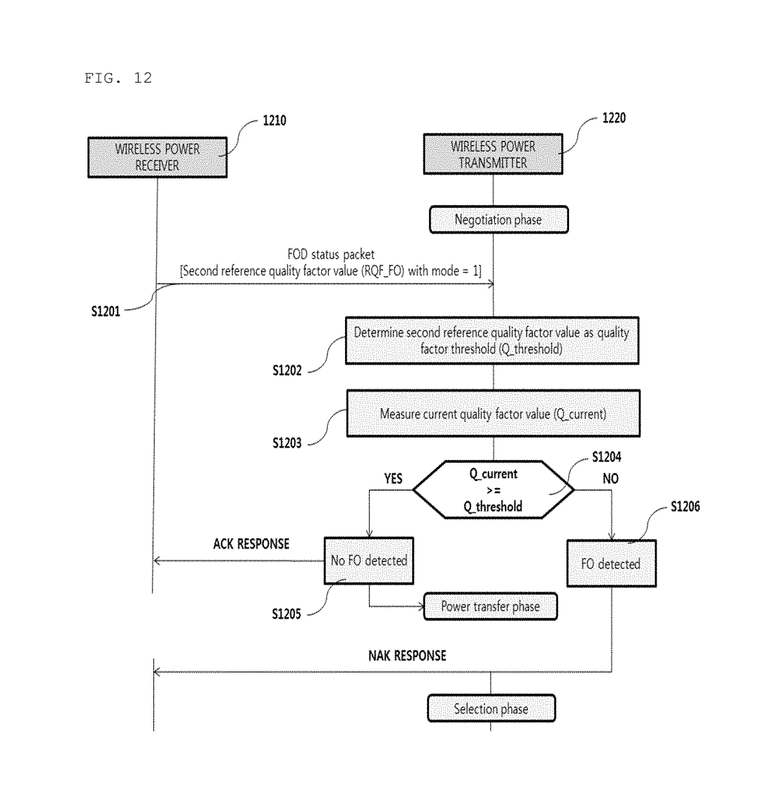

FIG. 12 is a flowchart illustrating an FOD detection method according to an embodiment.

Referring to FIG. 12, in the negotiation phase, a wireless power receiver 1210 may send a FOD status packet including a second reference quality factor value RQF_FO to a wireless power transmitter 1220 (S1201). At this time, the mode value of the FOD status packet may be set to a binary number ‘01’.

The second reference quality factor value may be determined to be the least value among the quality factor values measured at a plurality of points in the charging area of a specific wireless power transmitter designated for the performance test and maintained in the wireless power receiver.

For example, the second reference quality factor value RQF_FO may be determined to be the least value among a first quality factor measured at a central position where the primary coil and the secondary coil are well aligned in the presence of an FO near the wireless power receiver placed in the charging area and second quality factor values measured by shifting the wireless power receiver by a certain offset, which may be, but is not limited to, for example, +/−5 mm along the x-axis and y-axis, from the center without rotating the wireless power receiver in the presence of the FO near the wireless power receiver. Here, the second quality factor values may include quality factor values measured at at least four different positions.

The wireless power transmitter 1220 may determine the received second reference quality factor value as a quality factor threshold Q_threshold (S1203).

The wireless power transmitter 1220 may measure the current quality factor value Q_current and may determine whether the current quality factor value Q_current is greater than or equal to the quality factor threshold Q_threshold through comparison (S1203 and S1204).

As an example, the current quality factor value may be measured before the digital ping phase, be measured immediately before the negotiation (renegotiation) phase, or be periodically measured.

When the current quality factor value Q_current is greater than or equal to the quality factor threshold Q_threshold as a result of the comparison, the wireless power transmitter 1220 may determine that no FO is detected, and transmit an ACK response to the wireless power receiver 1210 (S1205). Then, the wireless power transmitter 1220 may transition from the negotiation phase to the power transfer phase.

When the current quality factor value Q_current is less than the quality factor threshold Q_threshold as a result of the comparison in operation 1204, the wireless power transmitter 1220 may determine that an FO is detected, and transmit a NAK response to the wireless power receiver 1210 (S1206). Then, the wireless power transmitter 1220 may transition from the negotiation phase to the selection phase.

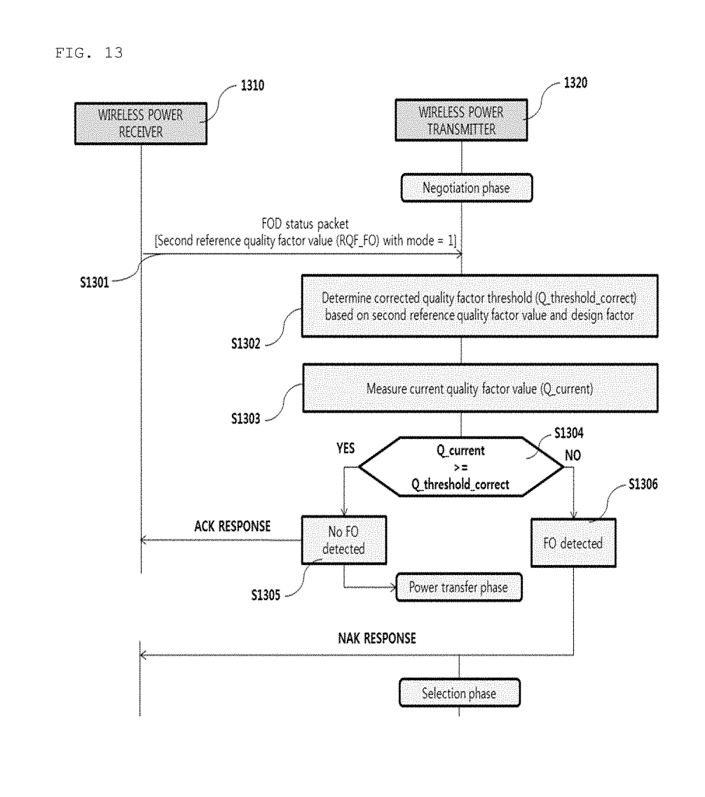

FIG. 13 is a flowchart illustrating an FOD detection method according to another embodiment.

Referring to FIG. 13, in the negotiation phase, the wireless power receiver 1310 may transmit an FOD status packet including a second reference quality factor value RQF_FO to the wireless power transmitter 1320 (S1301). At this time, the mode value of the FOD status packet may be set to a binary number ‘01’.

The second reference quality factor value may be determined to be the least value among the quality factor values measured at a plurality of points in the charging area of a specific wireless power transmitter designated for the performance test and maintained in the wireless power receiver.

For example, the second reference quality factor value RQF_FO may be determined to be the least value among a first quality factor value measured at a central position where the primary coil and the secondary coil are well aligned in the presence of an FO near the wireless power receiver placed in the charging area and second quality factor values measured by shifting the wireless power receiver by a certain offset, which may be, but is not limited to, for example, +/−5 mm along the x-axis and y-axis, from the center without rotating the wireless power receiver in the presence of the FO near the wireless power receiver. Here, the second quality factor values may include quality factor values measured at at least four different positions.

The wireless power transmitter 1320 may determine a threshold for FO detection based on the received second reference quality factor value and a pre-stored design factor corresponding to the wireless power transmitter 1320 (S1303). Hereinafter, for simplicity, the second reference quality factor value corrected based on the design factor will be referred to as a corrected quality factor threshold Q_threshold_correct.

Since the second reference quality factor value is determined based on the quality factor values measured on a specific wireless power transmitter designated for performance test (hereinafter referred to as a test wireless power transmitter), a wireless power transmitter manufactured for commercial use by a particular manufacturer (hereinafter referred to as a commercial wireless power transmitter for simplicity) may be different in configuration and characteristics from the test wireless power transmitter. Therefore, the quality factor value measured under the same conditions may differ between the commercial wireless power transmitter and the test wireless power transmitter. Therefore, the second reference quality factor value used as the threshold for FO detection in the embodiment of FIG. 12 described above needs to be corrected in consideration of the configuration and characteristics of the commercial wireless power transmitter, that is, the design factor.

In one example, the design factor may be a correction constant determined based on at least one parameter of a corresponding power class of the commercial wireless power transmitter, the characteristics and arrangement of the transmission coil, the power control algorithm embedded on the transmitter, the power transfer loss, and the shape and structure of the wireless power transmitter, but the present disclosure is not limited thereto. The design factor may be any value that may correct the measurement error of the quality factor value with respect to the test wireless power transmitter.

The wireless power transmitter 1320 may measure the current quality factor value Q_current and may determine whether the current quality factor value Q_current is greater than or equal to the corrected quality factor threshold Q_threshold_correct through comparison (S1303 to S1304).

For reference, the current quality factor value may be measured before the digital ping phase, be measured immediately before the negotiation (renegotiation) phase, or be periodically measured.

When the current quality factor value Q_current is greater than or equal to the corrected quality factor threshold Q_threshold_correct as a result of the comparison, the wireless power transmitter 1320 may determine that no FO is detected, and transmit an ACK response to the wireless power receiver 1310 (S1305). Then, the wireless power transmitter 1320 may transition from the negotiation phase to the power transfer phase.

When the current quality factor value Q_current is less than the corrected quality factor threshold Q_threshold_correct as a result of the comparison in operation 1304, the wireless power transmitter 1320 may determine that an FO is detected, and transmit a NAK response to the wireless power receiver 1310 (S1306). Then, the wireless power transmitter 1320 may transition from the negotiation phase to the selection phase.

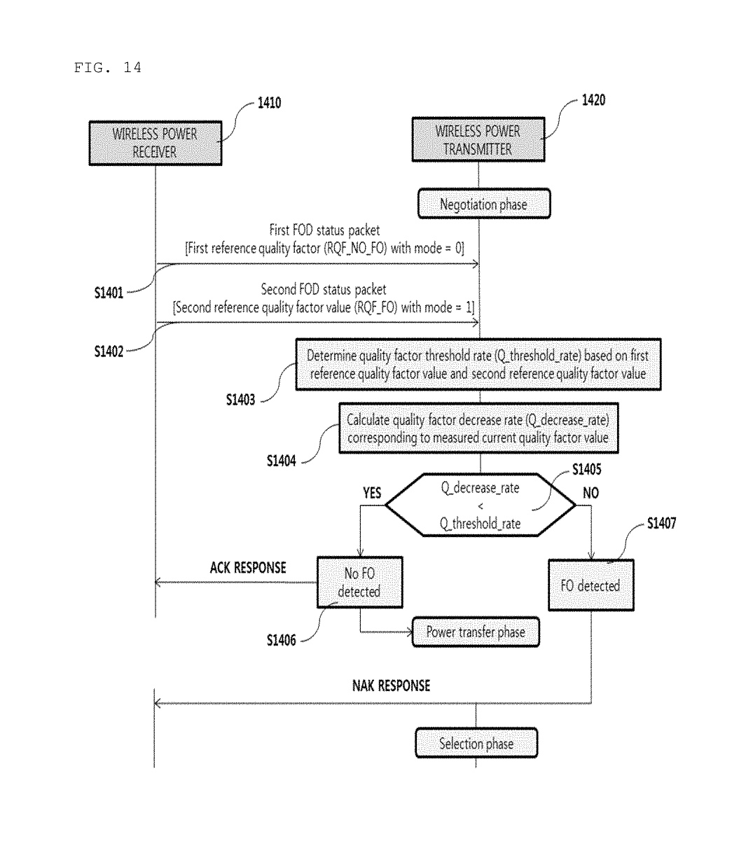

FIG. 14 is a flowchart illustrating an FOD detection method according to still another embodiment.

Referring to FIG. 14, in the negotiation phase, the wireless power receiver 1410 may transmit first or second FOD status packets including a reference quality factor value Q_reference to the wireless power transmitter 1420 (S1401 and S1402).

Here, the first FOD status packet may include a first reference quality factor value RQF_NO_FO given when the Mode is set to a binary number ‘00’. The second FOD status packet may include a second reference quality factor value RQF_FO given when the Mode is 1, i.e., a reference quality factor value determined based on the quality factor values measured in the presence of an FO in the charging area.

Here, the first reference quality factor value RQF_NO_FO is greater than the second reference quality factor value RQF_FO.

The first and second reference quality factor values may be determined based on the quality factor values measured in the presence of an FO near the receiver and in the absence of an FO near the receiver, respectively. In one example, the first or second reference quality factor value may be determined to be the least value among the quality factor values measured at a plurality of points in the charging area of a specific test wireless power transmitter.

For example, the first reference quality factor RQF_NO_FO may be determined to be the least value among a first quality factor value measured at a central position where the primary coil and the secondary coil are well aligned in the absence of an FO near the wireless power receiver placed in the charging area and by a certain offset, which may be, but is not limited to, for example, +/−5 mm along the x-axis and y-axis, from the center without rotating the wireless power receiver. Here, the second quality factor values may include quality factor values measured at at least four different positions.

The wireless power transmitter 1420 may determine a quality factor threshold rate Q_threshold_rate for FO detection based on the received first and second reference quality factor values (S1403).

Here, the quality factor threshold rate Q_threshold_rate may be calculated by dividing the difference between the first reference quality factor value RQF_NO_FO and the second reference quality factor value RQF_FO by the first reference quality factor value RQF_NO_FO. For example, when the first reference quality factor value RQF_NO_FO is 80 and the second reference quality factor value RQF_FO is 50, the quality factor threshold rate Q_threshold_rate may be calculated as (80−50)/80=0.375.

The wireless power transmitter 1420 may measure the current quality factor value Q_current and calculate a quality factor decrease rate Q_decrease_rate based on the measured current quality factor value and the first reference quality factor value RQF_NO_FO (S1404).

For reference, the current quality factor value may be measured before the digital ping phase, be measured immediately before the negotiation (renegotiation) phase, or be periodically measured.

The wireless power transmitter 1420 may determine whether the quality factor decrease rate Q_decrease_rate is less than the quality factor threshold rate Q_threshold_rate through comparison (S1405).

When the quality factor decrease rate is less than the quality factor threshold rate as a result of the comparison, the wireless power transmitter 1420 may determine that no FO is detected, and transmit an ACK to the wireless power receiver 1410 (S1406). Then, the wireless power transmitter 1420 may transition from the negotiation phase to the power transfer phase.

When the quality factor decrease rate Q_decrease_rate is greater than or equal to the quality factor threshold rate Q_threshold_rate as a result of the comparison in operation 1405 described above, the wireless power transmitter 1420 may determine that an FO is detected, and transmit a NAK response to the wireless power receiver 1410 (S1407). Then, the wireless power transmitter 1420 may transition from the negotiation phase to the selection phase.

While it is illustrated in the embodiment of FIG. 14 that the FO detection is performed by comparing the quality factor decrease rate Q_decrease_rate with the quality factor threshold rate Q_threshold_rate, but this is merely an embodiment. According to an embodiment, a wireless power transmitter may calculate a corrected quality factor threshold rate Q_threshold_rate correct based on a design factor corresponding to the wireless power transmitter and compare the quality factor decrease rate Q_decrease_rate with a corrected quality factor threshold rate Q_threshold_rate correct to determine whether or not an FO is present in the charging area.

In yet another embodiment, the quality factor threshold may be determined as follows.

The quality factor threshold may be determined in consideration of the received reference quality factor value and the quality factor measurement tolerance range (e.g. ±10% (0.1*the reference quality factor value), or the Accuracy of Quality Factor Value (FIG. 11D) and transmitter characteristics (transmitter type (design), manufacturer, product or measurement tolerance, etc.).

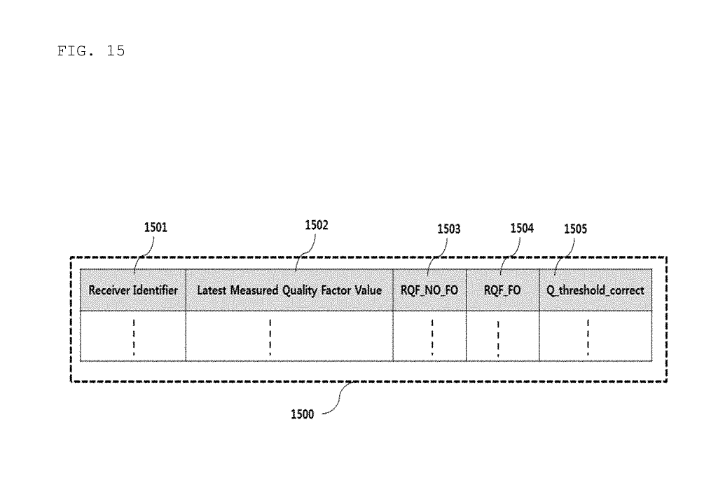

FIG. 15 shows a quality factor table according to an embodiment of the present disclosure.

A quality factor table 1500 shown in FIG. 15 may be maintained in the memory of the wireless power transmitter. The wireless power transmitter may update the quality factor table 1500 based on the received FO status packet. For example, the quality factor table 1500 may include at least one of a field of receiver identifier 1501, a field of latest measured quality factor value 1502, a field of first reference quality factor (RQF_NO_FO) 1503, a field of second reference quality factor value (RQF_FO) 1504, and a field of corrected quality factor threshold (Q_{—} threshold_{—} correct) 1505.

Here, the receiver identifier 1501 may be configured by one or a combination of at least one of a manufacturer code, a basic device identifier, and an extended device identifier obtained in the identification and configuration phase. For example, the receiver identifier may be configured by concatenating the manufacturer code and the basic device identifier. In another example, the receiver identifier may be configured by concatenating the manufacturer code, the basic device identifier, and the extended device identifier.

In the field of latest measured quality factor value 1502, the latest measured quality factor value corresponding to the receiver identifier 1501 may be recorded. Here, when charging of a wireless power receiver corresponding to the receiver identifier 1501 is normally completed or a normal state transition from the negotiation phase to the power transfer phase occurs, the wireless power transmitter may record the quality factor value measured in the negotiation phase in the quality factor table 1500.

In addition, when the wireless power transmitter receives an FOD status packet in the negotiation phase, it may record, in the quality factor table 1500, the second reference quality factor value RQF_FO or the first reference quality factor value RQF_NO_FO included in the FOD status packet.

In addition, the wireless power transmitter may record, in the quality factor table 1500, the corrected quality factor threshold Q_threshold_correct calculated for FO detection in the initial negotiation phase with the corresponding wireless power receiver.

Thereafter, when a wireless power receiver corresponding to the receiver identifier recorded in the quality factor table 1500 is detected, the wireless power transmitter may detect an FO with reference to the quality factor table 1500.

According to another embodiment of the present disclosure, the quality factor table 1500 may further at least one of the drop value of reference quality factor 1121 described in FIG. 11C and the accuracy of reference quality factor 1131 described in FIG. 11D.

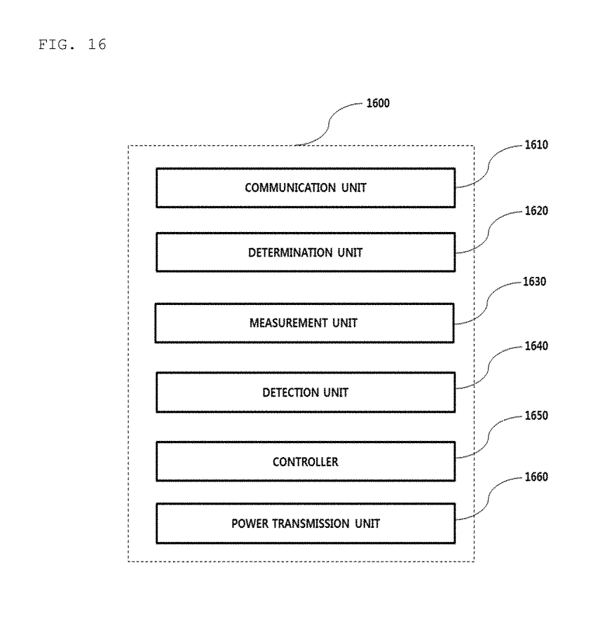

FIG. 16 is a block diagram illustrating a configuration of an FO detection device according to an embodiment.

An FO detection device 1600 according to an embodiment of the present disclosure may be mounted or embedded on a wireless power transmitter.

Referring to FIG. 16, the FO detection device 1600 may include a communication unit 1610, a determination unit 1620, a measurement unit 1630, a detection unit 1640, a controller 1650, and a power transmission unit 1660.

The communication unit 1610 may receive an FOD status packet including a reference quality factor value from a connected wireless power receiver in the negotiation phase. Here, the reference quality factor value may include at least one of a reference quality factor value (first reference quality factor value) RQF_NO_FO in the absence of an FO in the charging area and a reference quality factor value (second reference quality factor value) RQF_FO, and may be received via one FOD status packet or a plurality of FOD status packets in the negotiation phase.

The determination unit 1620 may determine a threshold to be used in FO detection based on the received reference quality factor value. For example, the threshold to be used for FO detection may be determined as the second reference quality factor value RQF_FO, but this is merely an embodiment. According to another embodiment of the present disclosure, the threshold to be used for FO detection may be determined as a second reference quality factor value corrected based on a design factor corresponding to the wireless power transmitter.

According to still another embodiment of the present disclosure, the threshold to be used for FO detection may be determined as a quality factor threshold rate Q_threshold_rate calculated based on the first and second reference quality factor values.

In a first embodiment, the quality factor threshold rate Q_threshold_rate may be calculated by dividing the difference between the first reference quality factor value RQF_NO_FO and the second reference quality factor value RQF_FO by the first reference quality factor value RQF_NO_FO. For example, when the first reference quality factor value RQF_NO_FO is 80 and the second reference quality factor value RQF_FO is 50, the quality factor threshold rate Q_threshold_rate may be calculated as (80−50)/80=0.375.

In a second embodiment, the quality factor threshold rate (Q_threshold_rate) may be determined as a value obtained by dividing the second reference quality factor value RQF_FO by the first reference quality factor value RQF_NO_FO. When the first reference quality factor value RQF_NO_FO is 80 and the second reference quality factor value RQF_FO is 50, the quality factor threshold rate Q_threshold_rate may be calculated as 50/80=0.625.

According to yet another embodiment of the present disclosure, the threshold to be used for FO detection may be determined as a corrected quality factor threshold rate Q_threshold_rate_correct calculated based on a first corrected reference quality factor and a second corrected reference quality factor calculated by applying a predetermined design factor corresponding to the wireless power transmitter to the first and second reference quality factor values.

In FO detection, the measurement unit 1630 may measure or calculate a value relate to the current quality factor that is compared with the above-described threshold.

For example, the measurement unit 1630 may measure the current quality factor value Q_current in the negotiation phase.

In addition, the measurement unit 1630 may calculate a quality factor decrease rate Q_decrease_rate based on the measured current quality factor value Q_current and the first reference quality factor value RQF_NO_FO. Here, the quality factor decrease rate Q_decrease_rate may be calculated as [RQF_NO_FO−Q_current]/[RQF_NO_FO].

The measurement unit 1630 may also calculate the current quality factor rate Q_current_rate based on the measured current quality factor value Q_current and the first reference quality factor value RQF_NO_FO. Here, the current quality factor rate Q_current_rate may be calculated as

[Q_current]/[RQF_NO_FO].

The detection unit 1640 may compare the threshold determined by the determination unit 1620 with the value measured or calculated by the measurement unit 1630 to detect presence or absence of an FO in the charging area.

For example, as shown in FIG. 12, when the current quality factor value Q_current is less than the second reference quality factor value RQF_FO, the detection unit 1640 may determine that an FO is present in the charging area.

As another example, as shown in FIG. 13, when the current quality factor value Q_current is less than the corrected quality factor threshold Q_threshold_correct, the detection unit 1640 may determine that an FO is present in the charging area.

As still another example, the detecting unit 1640 may determine whether an FO is present in the charging area by comparing the quality factor decrease rate Q_decrease_rate with the quality factor threshold rate Q_threshold_rate, as shown in FIG. 14.

In yet another example, the detection unit 1640 may determine whether an FO is present in the charging area by comparing the quality factor decrease rate Q_decrease_rate with a corrected quality factor threshold rate calculated based on a design factor corresponding to the wireless power transmitter.

In yet another example, the detection unit 1640 may determine the quality factor threshold as follows.

The quality factor threshold may be determined in consideration of the received reference quality factor value and the quality factor measurement tolerance range (e.g. ±10% (0.1*the reference quality factor value), or the Accuracy of Quality Factor Value (FIG. 11D) and transmitter characteristics (transmitter type (design), manufacturer, product or measurement tolerance, etc.).

The controller 1650 may control the overall operation and input/output of the FO detection device 1600. For example, when the FO is not detected by the detector 1640, the controller 1650 may make the wireless power transmitter transition from the negotiation phase to the power transfer phase, and control the power transmission unit 1660 to transmit power necessary for charging the load. In another example, when the FO is detected by the detecting unit 1640, the controller 1650 may make the wireless power transmitter transition from the negotiation phase to the selection phase, and control the power transmission unit 1660 to stop power transmission.

According to another embodiment of the present disclosure, the FO detection device 1600 may further include a memory (not shown) for maintaining the quality factor table 1500 shown in FIG. 15.

According to another embodiment of the present disclosure, the FO detection device 1600 may further include a correction unit (not shown) configured to calculate power loss between the wireless power receiver and the wireless power transmitter prior to a transition to the power transfer phase when the FO is not detected by the detecting unit 1640.

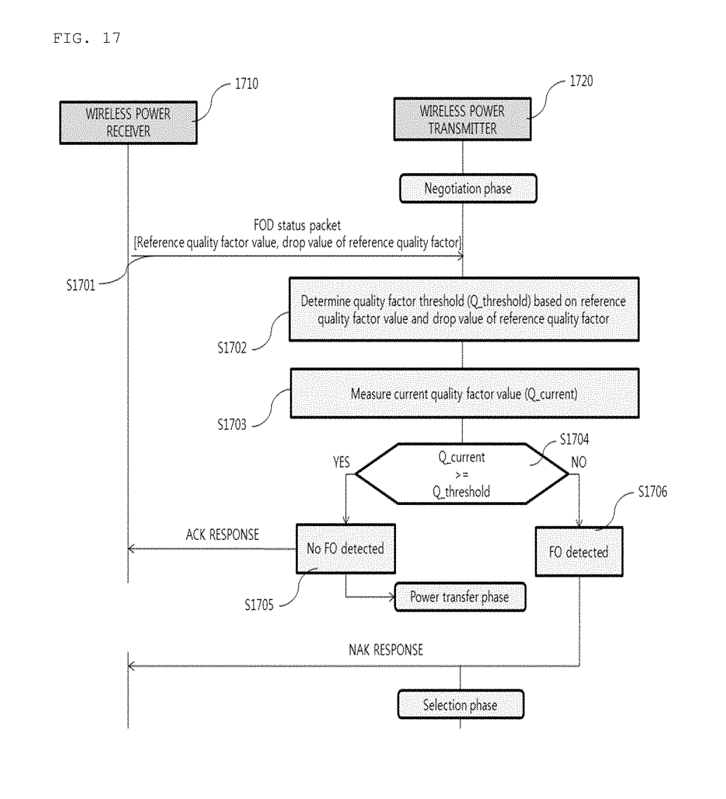

FIG. 17 is a flowchart illustrating an FOD detection method according to an embodiment.

Referring to FIG. 17, in the negotiation phase, a wireless power receiver 1710 may transmit, to a wireless power transmitter 1720, an FOD status packet including a Reference Quality Factor Value and a Drop Value of Reference Quality Factor (S1701). Here, the mode value of the FOD status packet may be set to a binary number ‘01’, but is not limited thereto.

Here, the reference quality factor value may be determined to be the least value among the quality factor values measured at a plurality of points in the charging area of a specific wireless power transmitter designated for the performance test and maintained in the wireless power receiver.

The wireless power transmitter 1720 may determine a quality factor threshold Q_threshold using the received reference quality factor value and the drop value of reference quality factor (S1703).

In one example, the wireless power transmitter 1720 may determine a obtained by subtracting the drop value of reference quality factor from the reference quality factor value as the quality factor threshold, but embodiments are not limited thereto. In another example, the quality factor threshold may be determined using a predetermined quality factor threshold generation function which has the reference quality factor value and the drop value of reference quality factor as input variables.

The wireless power transmitter 1720 may measure the current quality factor value Q_current and may determine whether the current quality factor value Q_current is greater than or equal to the quality factor threshold Q_threshold through comparison (S1703 and S1704).

For reference, the current quality factor value may be measured before the digital ping phase, be measured immediately before the negotiation (renegotiation) phase, or be periodically measured after the digital ping phase.

When the current quality factor value Q_current is greater than or equal to the quality factor threshold Q_threshold as a result of the comparison, the wireless power transmitter 1720 may determine that no FO is detected, and transmit an ACK response to the wireless power receiver 1710 (S1705). Then, the wireless power transmitter 1720 may transition from the negotiation phase to the power transfer phase.

When the current quality factor value Q_current is less than the quality factor threshold Q_threshold as a result of the comparison in operation 1704, the wireless power transmitter 1720 may determine that an FO is detected, and transmit a NAK response to the wireless power receiver 1710 (S1706). Then, the wireless power transmitter 1720 may transition from the negotiation phase to the selection phase.

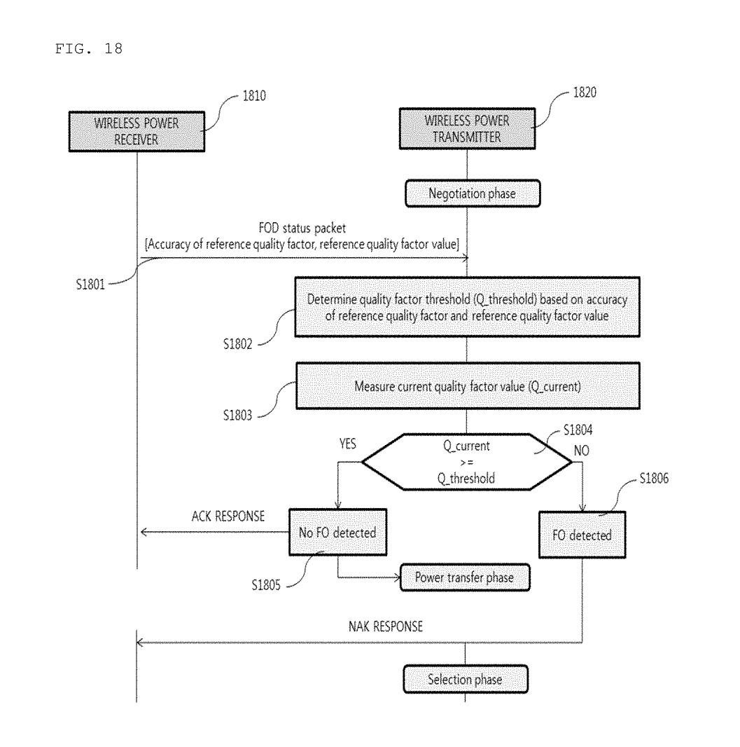

FIG. 18 is a flowchart illustrating an FOD detection method according to another embodiment.

Referring to FIG. 18, in the negotiation phase, a wireless power receiver 1810 transmits an FOD status packet including an accuracy of reference quality factor and a reference quality factor value to a wireless power transmitter 1820 (S1801). Here, the mode value of the FOD status packet may be set to a binary number ‘01’, but is not limited thereto.

Here, the reference quality factor value may be determined to be the least value among the quality factor values measured at a plurality of points in the charging area of a specific wireless power transmitter designated for the performance test and maintained in the wireless power receiver.

The wireless power transmitter 1820 may determine a quality factor threshold Q_threshold using the received accuracy of reference quality factor and reference quality factor value (S1803).

According to an embodiment of the present disclosure, the wireless power transmitter 1820 may determine the quality factor threshold further using a pre-stored production and measurement tolerance.

As an example, the wireless power transmitter 1820 may determine a value obtained by subtracting the accuracy of reference quality factor and the production and measurement tolerance from the reference quality factor value as the quality factor threshold, but embodiments are not limited thereto. In another example, the quality factor threshold may be determined using a predetermined quality factor threshold generation function which has the accuracy of reference quality factor and the reference quality factor value as input variables.

The wireless power transmitter 1820 may measure the current quality factor value Q_current and may determine whether the current quality factor value Q_current is greater than or equal to the quality factor threshold Q_threshold through comparison (S1803 and S1804).

According to an embodiment of the present disclosure, the current quality factor value may be measured before the digital ping phase, be measured immediately before the negotiation (renegotiation) phase, or be periodically measured after the digital ping phase.

When the current quality factor value Q_current is greater than or equal to the quality factor threshold Q_threshold as a result of the comparison, the wireless power transmitter 1820 may determine that no FO is detected, and transmit an ACK response to the wireless power receiver 1810 (S1805). Then, the wireless power transmitter 1820 may transition from the negotiation phase to the power transfer phase.

When the current quality factor value Q_current is less than the quality factor threshold Q_threshold as a result of the comparison in operation 1804, the wireless power transmitter 1820 may determine that an FO is detected, and transmit a NAK response to the wireless power receiver 1810 (S1806). Then, the wireless power transmitter 1820 may transition from the negotiation phase to the selection phase.

A wireless power transmitter according to another embodiment of the present disclosure may acquire a reference quality factor value, accuracy of reference quality factor, and a drop value of reference quality factor through a plurality of FOD status packets. Then, the wireless power transmitter may determine the quality factor threshold using at least one of the reference quality factor value, the accuracy of reference quality factor, the drop value of reference quality factor, and a production and measurement tolerance. For example, the wireless power transmitter may determine, as the quality factor threshold, an output value of a predetermined quality factor threshold generation function having the reference quality factor value, the accuracy of reference quality factor, and the drop value of reference quality factor as input variables.

A wireless power transmitter according to still another embodiment of the present disclosure may obtain, from a wireless power receiver, a quality factor value, accuracy of reference quality factor, and a drop value of reference quality factor measured through a plurality of FOD status packets in the absence of a foreign object. For example, the wireless power transmitter may determine a value obtained by subtracting the accuracy of reference quality factor and the drop value of reference quality factor from the quality factor value measured in the absence of a foreign object as the quality factor threshold. In another example, the wireless power transmitter may determine an output value of a predetermined quality factor threshold generation function having, as input variables, the reference quality factor value, the accuracy of reference quality factor, and the drop value of reference quality factor measured in the absence of a foreign object.

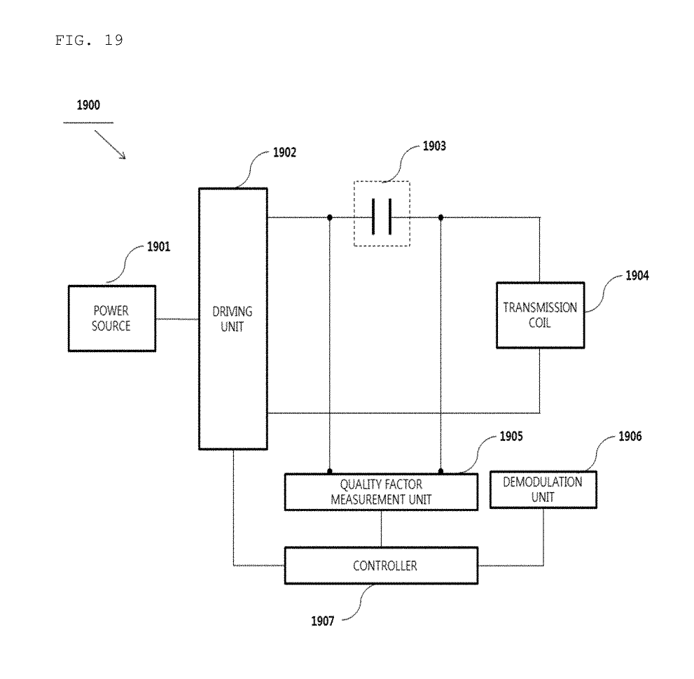

FIG. 19 is a block diagram illustrating a configuration of an FO detection device according to an embodiment.

Referring to FIG. 19, an FO detection device 1900 may include a driving unit 1902, a resonant capacitor 1903, a transmission coil 1904, a quality factor measurement unit 1905, a demodulation unit 1906, and a controller 1907.

The driving unit 1902 may convert the DC power supplied from a power source 1901 to AC power and adjust the intensity of the AC power according to a control signal of the controller 1907. The driving unit 1902 may include a frequency oscillator configured to generate a specific frequency signal and an inverter configured to amplify the AC signal generated by the frequency oscillator.

The quality factor measurement unit 1905 may measure a quality factor value for the transmission coil by monitoring a change in inductance (or a voltage or a current) between both ends of the resonant capacitor 103. The measured current quality factor value is transmitted to the controller 1907.

The demodulator 1906 demodulates the signal received from the wireless power receiver and transmits the demodulated signal to the controller 1907. For example, the demodulation unit 1906 may demodulate an FO status packet and transmit the demodulated FO status packet to the controller 1907.

The controller 1907 may determine a quality factor threshold for the wireless power receiver based on at least one of a reference quality factor value, accuracy of reference quality factor, and a drop value of reference quality factor included in the FO status packet.

The controller 1907 may determine whether an FO is present in the charging area by comparing the determined quality factor threshold with the current quality factor measured by the quality factor measurement unit 1905.

The controller 1907 may continue charging or stop charging and return to the selection phase depending on the determination result.

For details of a specific function of the controller 1907 to adaptively determine the quality factor threshold based on the FO status packet and a function of detecting an FO based on the determined quality factor threshold, see the description of FIGS. 1 to 18.

The method according to embodiments of the present disclosure may be implemented as a program to be executed on a computer and stored in a computer-readable recording medium. Examples of the computer-readable recording medium include ROM, RAM, CD-ROM, magnetic tapes, floppy disks, and optical data storage devices, and also include carrier-wave type implementation (e.g., transmission over the Internet).

The computer-readable recording medium may be distributed to a computer system connected over a network, and computer-readable code may be stored and executed thereon in a distributed manner. Functional programs, code, and code segments for implementing the method described above may be easily inferred by programmers in the art to which the embodiments pertain.

It is apparent to those skilled in the art that the present disclosure may be embodied in specific forms other than those set forth herein without departing from the spirit and essential characteristics of the present disclosure.

Therefore, the above embodiments should be construed in all aspects as illustrative and not restrictive. The scope of the disclosure should be determined by the appended claims and their legal equivalents, and all changes coming within the meaning and equivalency range of the appended claims are intended to be embraced therein.

### INDUSTRIAL APPLICABILITY

The embodiments may be used in the field of wireless charging and is particularly applicable to wireless power transmission devices.

1-15. (canceled)

16. A method of detecting a foreign object (FO) by a wireless power transmitter, the method comprising:
receiving a packet including a reference quality factor value;
determining a threshold using the reference quality factor value;
measuring a current quality factor value; and
detecting an FO based on the threshold and the current quality factor value,
wherein the packet further comprises a predetermined mode value indicating that the reference quality factor value is a value corresponding to presence of the FO in a charging area.

17. The method according to claim 16, wherein the packet is received in a negotiation phase,
wherein, when the FO is detected in the negotiation phase, a state of the wireless power transmitter transitions to a selection phase, and
wherein, when the FO is not detected in the negotiation phase, the state of the wireless power transmitter transitions to a power transfer phase.

18. The method according to claim 16, wherein the threshold is determined using the reference quality factor value included in the packet and a design factor corresponding to the wireless power transmitter, and
wherein the design factor is a constant value for correcting a measurement tolerance of a quality factor value of the wireless power transmitter with respect to a quality factor value of a reference wireless power transmitter for authentication.

19. The method according to claim 18, wherein the design factor is a constant value determined based on at least one of a power class of the wireless power transmitter, a characteristic of a transmission coil mounted on the wireless power transmitter, and an arrangement of the transmission coil.

20. The method according to claim 16, further comprising:
when the FO is not detected, recording, in a predetermined quality factor table, at least one of a receiver identifier corresponding to a wireless power receiver having transmitted the packet, the reference quality factor value, the threshold, and the current quality factor value.

21. The method according to claim 20, wherein, when the wireless power receiver is reconnected, the FO is detected with reference to the quality factor table.

22. A foreign object (FO) detection device comprising:
a communication unit configured to receive a packet including a reference quality factor value;
a determining unit configured to determine a threshold using the reference quality factor value;
a measurement unit configured to measure a current quality factor value; and
a detection unit configured to detect an FO based on the threshold and the current quality factor value,
wherein the packet further comprises a predetermined mode value indicating that the reference quality factor value is a value corresponding to presence of the FO in a charging area.

23. The FO detection device according to claim 22, wherein the determination unit determines the threshold using the reference quality factor value and a design factor corresponding to the wireless power transmitter on which the FO detection device is mounted, and
wherein the design factor is a constant value for correcting a measurement tolerance of a quality factor value of the wireless power transmitter with respect to a quality factor value of a reference wireless power transmitter for authentication.

24. The FO detection device according to claim 23, wherein the design factor is a constant value determined based on at least one of a power class of the wireless power transmitter, a characteristic of a transmission coil mounted on the wireless power transmitter, and an arrangement of the transmission coil.

25. The FO detection device according to claim 22, further comprising:
a memory configured to maintain a quality factor table including at least one of a receiver identifier corresponding to a wireless power receiver having transmitted the packet, the reference quality factor value, the threshold value, and the current quality factor value when the FO is not detected.

26. The FO detection device according to claim 25, wherein, when the wireless power receiver is reconnected, the determination unit detects the FO with reference to the quality factor table.
